(19) United States
(12) Patent Application Publication
(10) Pub. No.: US 2014/0119511 A1
(43) Pub. Date: May 1, 2014

(54) Methods of Identifying Original and Counterfeit Articles using Micro X-Ray Diffraction Mapping

(71) Applicants: Michael Ward, New York, NY (US); Daniele Musumeci, New York, NY (US); Chunhua Hu, Forest Hills, NY (US)

(72) Inventors: Michael Ward, New York, NY (US); Daniele Musumeci, New York, NY (US); Chunhua Hu, Forest Hills, NY (US)

(21) Appl. No.: 14/126,031

(22) PCT Filed: Jun. 14, 2012
(86) PCT No.: PCT/US2012/042443

§ 371 Date: Dec. 13, 2013

Related U.S. Application Data
(60) Provisional application No. 61/520,784, filed on Jun. 15, 2011.

(51) Int. Cl. G01N 23/207

(52) U.S. Cl. CPC G01N 23/207
USPC 378/71; 283/74

(57) ABSTRACT

The present invention provides relatively fast, automated and non-destructive methods to screen and identify articles. The methods may be used to identify counterfeit articles, such as, for example, medications including those in the form of tablets, pills or capsules. The methods may use a micro-X ray diffraction method to scan marks as small as, for instance, 300 μm made of X-ray visible compounds. The methods may provide 2-D or 3-D maps of these marks using selected peaks from the collected X-ray diffraction patterns and may be used to certify the authenticity of drug tablets, for instance by mapping hidden marks printed under tablet coatings and on packages.

### FIELD OF THE INVENTION

The present invention is in the field of X-ray diffraction mapping and provides generally methods for identifying articles or for authenticating articles. Likewise, the present invention provides generally methods for identifying counterfeit articles.

### BACKGROUND

Pharmaceutical counterfeiting is a global public health problem that is increasingly receiving international interest. (Counterfeit Drugs, Guidelines for the Development of Measures to Combat Counterfeit Drugs, Department of Essential Drugs and Other Medicines, World Health Organization, Geneva, Switzerland, 1999; Declaration of Rome, Conclusions and Recommendations of the WHO International Conference on Combating Counterfeit Medicines, 18 Feb., 2006; Combating Counterfeit Drugs: A Concept Paper for Effective International Cooperation, World Health Organization, Health Technology and Pharmaceuticals, WHO, 27 Jan., 2006.) Drug counterfeiting especially affects developing countries where drug regulations are perhaps less effective, and it involves particularly pharmaceutical products such as antibiotics, antimicrobials, anti-sexual dysfunction remedies, hormones and steroids. (Combating Counterfeit Drugs: A Concept Paper for Effective International Cooperation, World Health Organization, Health Technology and Pharmaceuticals, WHO, 27 Jan., 2006; World Health Assembly, Counterfeit Drugs: Threat to Public Health, vol. 55, World Health Assembly, Geneva, 2002.) Counterfeit drugs may contain an incorrect amount of active principle ingredients (API), no API or even contain the wrong active principle ingredients. (Counterfeit Drugs, Guidelines for the Development of Measures to Combat Counterfeit Drugs, Department of Essential Drugs and Other Medicines, World Health Organization, Geneva, Switzerland, 1999) Such counterfeit drugs may be manufactured illegally without meeting the good manufacturing practice (GMP) standards, and the poor quality of such counterfeit drugs may lead to therapeutic failure, drug resistance and, in some cases, death. (Combating Counterfeit Drugs: A Concept Paper for Effective International Cooperation, World Health Organization, Health Technology and Pharmaceuticals, WHO, 27 January, 2006.) Furthermore, the financial consequences of counterfeit drugs for companies producing genuine products can be enormous. (Cockburn, et al., PLoS Med. 2005; 2:e100; Saywell, et al., Far East Econ. Rev. 2002; 34-40.) Therefore, the development of new technologies aimed to prevent, deter or detect counterfeit medicinal products is desirable.

Several anti-counterfeiting measures currently adopted by some pharmaceutical manufacturers involve package tracking using radio frequency tags, barcodes, watermarks, fluorescent inks, and chemical and biological tags. (Deisingh, Analyst 2005; 130: 271-279) Radio frequency identification is fast and easy to use, but the cost is still prohibitive. (Deisingh, Analyst 2005; 130: 271-279) Barcodes and watermarks may be detected by a simple digital scanner, therefore they may be easily counterfeited. (Deisingh, Analyst 2005; 130: 271-279) Furthermore, such methods are effective only if distributors do not repackage the drugs when they are received from manufacturers, and authentic packages do not necessarily verify the authenticity of the content. Tags directly applied to the drug, combined with package labeling, would increase the efficacy of anti-counterfeit methods.

Current methods to certify the authenticity of drugs involve standard analytical techniques (Baert et al., Anal. Bioanal. Chem. 2010; 398: 125-136), including liquid chromatography coupled with mass spectroscopy (Vredenbregt et al., J. Pharm. Biomed. Anal. 2006; 40: 840-849; Zhou et al., Chromatogr. A 2006; 1104: 113-122; Liang, et al., Pharm. Biomed. Anal. 2006; 40: 305-311), capillary gas chromatography, (Berzas et al., Chromatographia 2002; 55: 601-606), thin layer chromatography (Vredenbregt et al., J. Pharm. Biomed. Anal. 2006; 40: 840-849; Mikami et al., Forensic Sci. Int. 2002; 130: 140-146), UV-VIS (Vredenbregt et al., J. Pharm. Biomed. Anal. 2006; 40: 840-849; Alhussaini. Sci. Justice 1996; 36: 139-142), NMR (¹H, ¹³C, ¹⁵N) and 2D DOSY ¹H NMR (Wawer et al., J. Pharm. Biomed. Anal. 2005; 38: 865-870; Trefi et al., J. Pharm. Biomed. Anal. 2008; 47: 103-113; Trefi, et al., Magn. Reson. Chem. 2009; 47: S163-S173). However, these techniques require sample preparation and they may be destructive and time consuming. Near-infrared spectroscopy (NIRS) and Raman spectroscopy are not destructive and fast methods to detect counterfeit drugs. (Vredenbregt et al., J. Pharm. Biomed. Anal. 2006; 40: 840-849; De Weij et al., J. Pharm. Biomed. Anal. 2008; 46: 303-309) NIRS may be used to determine the homogeneity of a batch and to screen for the presence of the API, however, standard analytical methods are still necessary for definitive confirmation. (Vredenbregt et al., J. Pharm. Biomed. Anal. 2006; 40; 840-849.) Raman spectroscopy provides unique “fingerprints” of API and excipients, but it requires skilled personnel for spectral interpretation and, in order to be automated, elaborated chemometric analyses and databases. (De Weij, et al., J. Pharm. Biomed. Anal. 2008; 46: 303-309) Moreover, NIRS and Raman spectroscopy are commonly used in laboratories, and it is easy for counterfeiters to access such technologies in order to duplicate the original products. X-ray powder diffraction (XRPD) is used in the pharmaceutical industry for polymorph identification of API by detecting distinctive diffraction peaks. Recent studies employed this technique for identifying counterfeit drugs, and it proved it to be fast and relatively non-destructive method, but with the same disadvantages of NIRS and Raman. (Maurin et al., J. Pharm. Biomed. Anal. 2007; 43: 1514-1518.)

Bendele, DE 102009022388 teaches providing an original product with a marking, e.g. UV marking. The original product is identified by x-ray radiation or radiation in the tetrahertz range or by a combination of both radiations. The marking on the original product may contain silicon dioxide, silicate, an aluminum containing compound, cerium, neodymium, a ceramic, tantalum, lanthanum, gadolinium thallium, samarium, or an inorganic or organic polymer compound. An x-ray scanner, a computer tomography scanner and a tetrahertz spectrometer are used. The method provides for identifying original products and imitator products.

X-ray diffraction (XRD) analysis performed on small samples or small areas of large samples is commonly referred to as microdiffraction. Considered the technique of choice when samples are too small for the optics and accuracy of conventional diffraction instrumentation, the method employs a micro X-ray beam so that diffraction characteristics can be mapped as a function of sample position. With the ability to accurately and precisely position a small X-ray beam on a sample surface, the information can be plotted as a diffraction function map (DFM). Diffraction data can contain information about compound identification, crystallite orientation (texture), stress, crystallinity, and crystallite size. The field of microdiffraction is rapidly growing in materials research and fabrication because smaller domains now affect product yield and reliability. Applications for microdiffraction analysis include: test pads on patterned wafers, compound libraries formed by combinatorial chemistry, inclusions on geological specimens, failure analysis of metal or plastic components, and quality control (QC) in manufacturing.

Micro-diffraction analysis is generally used when a small (e.g. a spot on a) sample needs to be investigated. Where samples are not homogeneous in composition, lattice strain, or preferred orientation of crystallites, localized measurements must be performed in order to obtain spatially resolved information about the microstructural properties of the sample. In this case, only a very small area of the sample has to be irradiated. This can be achieved with dedicated incident beam collimators that reduce the emitted X-rays to a very narrow beam. With the use of a mono-capillary, for example, it is possible to produce an incident X-ray beam with a diameter down to 10 μm.

### SUMMARY OF THE INVENTION

In a first aspect, the present invention provides a method for identifying an authentic or original article by

A) providing a mark on the article that may be identified by micro x-ray diffraction;

B) providing x-ray radiation to identify the mark;

C) analyzing the presence of or position of the mark on the article; and

D) determining whether the mark is substantially identical to the mark provided in A).

The presence of or position of the mark may be analyzed or identified with respect to one-dimension or two-dimensions. The presence of or position of the mark may be identified using, for instance, an x-ray micro-diffractometer. The mark may contain one or more components, such as, for example, one or more compounds. In some embodiments, there may be one, two, three, four, five, six, seven, eight, nine, ten, twelve, fifteen, twenty, thirty or more compounds present in the mark. The one or more compounds may be substantially in a crystalline form or phase or completely in a crystalline form or phase. Likewise, analyzing the presence of or position of the mark may be performed by identifying the presence, quantity, or relative quantity of one, more than one, or all of the compounds present in the mark such as, for instance, one, two, three, four, five, six, seven, eight, nine, ten, twelve, fifteen, twenty, thirty or more compounds present in the mark. Similarly, analyzing the presence of or position of the mark may be performed by identifying the percentage crystallinity of one, more than one, or all of the compounds present in the mark such as, for instance, one, two, three, four, five, six, seven, eight, nine, ten, twelve, fifteen, twenty, thirty or more compounds present in the mark.

In some embodiments, the methods use a micro-diffractometer that may be equipped with one or more collimators that enable acquiring diffraction patterns on relative sample areas. The sample areas may be as small as, for instance, 0.50 μm, 1 μm, 10 μm, 25 μm, 100 μm, 200 μm, 300 μm, 500 μm, 700 μm or 800 μm, 1 mm, 2 mm, 3 mm or so. The methods may feature analyzing substantially the entire diffraction pattern of the mark. Also, the methods may feature analyzing only a few, for instance one, two, three, four, five, six, seven, eight, nine, ten, eleven, twelve, fifteen, twenty, thirty, or so selected peaks of the mark to map the mark X-ray patterns.

The article may be, for example, a drug such as a tablet, pill or capsule. The drug may be present in a package or an envelope. The article may also be any other consumer good, such as, for example, eyeglasses, writing instruments, artwork, decorative accessories, paintings, scientific gadgets or machines, scientific apparatuses, a piece of clothing or shoes, a piece of luggage, a purse, a briefcase, a watch, an item of jewelry, a sporting device or instrument, or a limited edition of any of the foregoing or other articles.

The mark may form a substantial barcode. The barcode may be of any suitable size and may be formed of two, three, four, five, six, seven, eight, nine, ten, eleven, twelve, fifteen, twenty, thirty, forty, fifty or more bars. Each bar may be about 300 μm, 500 μm, 700 μm or 800 μm or 1 mm or so long and about 0.50 μm, 1 μm, 10 μm, 25 μm, 100 μm, 200 μm, 300 μm, 500 μm, 700 μm or 800 μm or 1 mm or so wide. Likewise, the bars may be separated by about 0.50 μm, 1 μm, 10 μm, 25 μm, 100 μm, 200 μm, 300 μm, 500 μm, 700 μm or 800 μm or 1 mm or so. It may be made of any suitable X-ray visible compound. When applied to a medicament such as a tablet, pill or capsule, the marker may be made of any FDA approved X-ray visible compound. The marker may be applied to a substantially flat surface. The mark may or may not be visible by eye. Examples of suitable marks include, for instance, rutile, zinc oxide, magnesium oxide, talc and iron oxide. The mark may in some instances be present on the surface of the article, or the mark may be substantially hidden underneath a coating. The mark may in some instances be applied to the article manually using, for instance, soft lithography stamping.

The resolution of the X-ray beam depends in part on the θ₁ angle and the diameter of the collimator D_{c}. As such, in some instances, the D_{c} may be about 1 μm, 10 μm, 25 μm, 100 μm, 200 μm, 300 μm, 500 μm, 700 μm or 800 μm or so, and the θ₁ may be about 10°, 20°, 30°, 40°, 50°, 60°, 70°, 80°, 90°, 100°, 110°, 120° or so. In some instances, the area mapped may be, for instance, from 1-10 mm, 2-8 mm, 3-7 mm or 4-6 mm by 1-10 mm, 2-8 mm, 3-7 mm or 4-6 mm. In some instances, the mapping may be performed in a few seconds, such as, for instance, 30, 60, 90, 120, 150, 180, 210 or 240 seconds, a few minutes or a few hours, for instance, 2-3 hours.

In a second aspect, the present invention provides a method for identifying a counterfeit article or a copy of an original article by

A) providing a mark on a first original article that may be identified by micro x-ray diffraction;

B) providing x-ray radiation to identify the mark;

C) providing a first original article or a second counterfeit article or copy of the first original article;

D) analyzing the presence of or the position of the mark on the article; and

E) determining whether the mark is substantially identical to the mark provided in A).

The presence of or position of the mark may be analyzed or identified with respect to one-dimension or two-dimensions. The presence of or position of the mark may be identified using, for instance, an x-ray micro-diffractometer. The mark may contain one or more components, such as, for example, one or more compounds. In some embodiments, there may be one, two, three, four, five, six, seven, eight, nine, ten, twelve, fifteen, twenty, thirty or more compounds present in the mark. The one or more compounds may be substantially in a crystalline form or phase or completely in a crystalline form or phase. Likewise, analyzing the presence of or position of the mark may be performed by identifying the presence, quantity, or relative quantity of one, more than one, or all of the compounds present in the mark such as, for instance, one, two, three, four, five, six, seven, eight, nine, ten, twelve, fifteen, twenty, thirty or more compounds present in the mark. Similarly, analyzing the presence of or position of the mark may be performed by identifying the percentage crystallinity of one, more than one, or all of the compounds present in the mark such as, for instance, one, two, three, four, five, six, seven, eight, nine, ten, twelve, fifteen, twenty, thirty or more compounds present in the mark.

In some embodiments, the methods use a micro-diffractometer that may be equipped with one or more collimators that enable acquiring diffraction patterns on relative sample areas. The sample areas may be as small as, for instance, 0.50 μm, 1 μm, 10 μm, 25 μm, 100 μm, 200 μm, 300 μm, 500 μm, 700 μm or 800 μm or so. The methods may feature analyzing substantially the entire diffraction pattern of the marker. Also, the methods may feature analyzing only a few, for instance one, two, three, four, five, six, seven, eight, nine, ten, eleven, twelve, fifteen, twenty, thirty, or so selected peaks of the marker to map marker X-ray patterns.

The article may be, for example, a drug such as a tablet, pill or capsule. The drug may be present in a package or an envelope. The article may also be any other consumer good, such as, for example, eyeglasses, writing instruments, artwork, decorative accessories, paintings, scientific gadgets or machines, scientific apparatuses, a piece of clothing or shoes, a piece of luggage, a purse, a briefcase, a watch, an item of jewelry, a sporting device or instrument, or a limited edition of any of the foregoing or other articles.

The mark may form a substantial barcode. The barcode may be of any suitable size and may be formed of two, three, four, five, six, seven, eight, nine, ten, eleven, twelve, fifteen, twenty, thirty, forty, fifty or more bars. Each bar may be about 300 μm, 500 μm, 700 μm or 800 μm or 1 mm or so mm long and about 0.50 μm, 1 μm, 10 μm, 25 μm, 100 μm, 200 μm, 300 μm, 500 μm, 700 μm or 800 μm or 1 mm or so wide. Likewise, the bars may be separated by about 0.50 μm, 1 μm, 10 μm, 25 μm, 100 μm, 200 μm, 300 μm, 500 μm, 700 μm or 800 μm or 1 mm or so. It may be made of any suitable X-ray visible compound. When applied to a medicament such as a tablet, pill or capsule, the marker may be made of any FDA approved X-ray visible compound. The mark may be applied to a substantially flat surface. The marker may or may not be visible by eye. Examples of suitable marks include, for instance, rutile, zinc oxide, magnesium oxide, talc and iron oxide. The mark may in some instances be present on the surface of the article, or the mark may be substantially hidden underneath a coating. The mark may in some instances be applied to the article manually using, for instance, soft lithography stamping.

The resolution of the X-ray beam depends in part on the θ₁ angle and the diameter of the collimator D_{c}. As such, in some instances, the 13, may be about 0.50 μm, 1 μm, 10 μm, 25 μm, 100 μm, 200 μm, 300 μm, 500 μm, 700 μm or 800 μm or so, and the θ₁ may be about 10°, 20°, 30°, 40°, 50°, 60°, 70°, 80°, 90°, 100°, 110°, 120° or so. In some instances, the area mapped may be, for instance, from 1-10 mm, 2-8 mm, 3-7 mm or 4-6 mm by 1-10 mm, 2-8 mm, 3-7 mm or 4-6 mm. In some instances, the mapping may be performed in a few seconds, such as, for instance, 30, 60, 90, 120, 150, 180, 210 or 240 seconds, a few minutes or a few hours, for instance, 2-3 hours.

In a third aspect, the present invention provides an X-ray diffraction method useful for identifying original articles and useful for identifying counterfeit articles. The method features

A) providing a mark on an article that may be identified by micro x-ray diffraction;

B) providing x-ray radiation to identify the mark;

C) analyzing the presence of or position of the mark on the article; and

D) determining whether the mark is substantially identical to the mark provided in A).

The presence of or position of the mark may be analyzed or identified with respect to one-dimension or two-dimensions. The presence of or position of the mark may be identified using, for instance, an x-ray micro-diffractometer. The mark may contain one or more components, such as, for example, one or more compounds. In some embodiments, there may be one, two, three, four, five, six, seven, eight, nine, ten, twelve, fifteen, twenty, thirty or more compounds present in the mark. The one or more compounds may be substantially in a crystalline form or phase or completely in a crystalline form or phase. Likewise, analyzing the presence of or position of the mark may be performed by identifying the presence, quantity, or relative quantity of one, more than one, or all of the compounds present in the mark such as, for instance, one, two, three, four, five, six, seven, eight, nine, ten, twelve, fifteen, twenty, thirty or more compounds present in the mark. Similarly, analyzing the presence of or position of the mark may be performed by identifying the percentage crystallinity of one, more than one, or all of the compounds present in the mark such as, for instance, one, two, three, four, five, six, seven, eight, nine, ten, twelve, fifteen, twenty, thirty or more compounds present in the mark.

In some embodiments, the methods use a micro-diffractometer that may be equipped with one or more collimators that enable acquiring diffraction patterns on relative sample areas. The sample areas may be as small as, for instance, 0.50 μm, 1 μm, 10 μm, 25 μm, 100 μm, 200 μm, 300 μm, 500 μm, 700 μm or 800 μm or so. The methods may feature analyzing substantially the entire diffraction pattern of the mark. Also, the methods may feature analyzing only a few, for instance one, two, three, four, five, six, seven, eight, nine, ten, eleven, twelve, fifteen, twenty, thirty, or so selected peaks of the mark to map the mark X-ray patterns.

The article may be, for example, a drug such as a tablet, pill or capsule. The drug may be present in a package or an envelope. The article may also be any other consumer good, such as, for example, eyeglasses, writing instruments, artwork, decorative accessories, paintings, scientific gadgets or machines, scientific apparatuses, a piece of clothing or shoes, a piece of luggage, a purse, a briefcase, a watch, an item of jewelry, a sporting device or instrument, or a limited edition of any of the foregoing or other articles.

The mark may form a substantial barcode. The barcode may be of any suitable size and may be formed of two, three, four, five, six, seven, eight, nine, ten, eleven, twelve, fifteen, twenty, thirty, forty, fifty or more bars. Each bar may be about 0.50 mm, 1, 2, 3, 4, 5, 6, 8, 10, 12, 14, 16, 18, 20, 25, 30, 40, 50 or so mm long and about 0.50 μm, 1 μm, 10 μm, 25 μm, 100 μm, 200 μm, 300 μm, 500 μm, 700 μm or 800 μm or 1 mm or so wide. Likewise, the bars may be separated by about 0.50 μm, 1 μm, 10 μm, 25 μm, 100 μm, 200 μm, 300 μm, 500 μm, 700 μm or 800 μm or 1 mm or so. It may be made of any suitable X-ray visible compound. When applied to a medicament such as a tablet, pill or capsule, the mark may be made of any FDA approved X-ray visible compound. The mark may be applied to a substantially flat surface. The mark may or may not be visible by eye. Examples of suitable marks include, for instance, rutile, zinc oxide, magnesium oxide, talc and iron oxide. The mark may in some instances be present on the surface of the article, or the marker may be substantially hidden underneath a coating. The mark may in some instances be applied to the article manually using, for instance, soft lithography stamping.

The resolution of the X-ray beam depends in part on the θ₁ angle and the diameter of the collimator D_{c}. As such, in some instances, the D, may be about 0.50 μm, 1 μm, 10 μm, 25 μm, 100 μm, 200 μm, 300 μm, 500 μm, 700 μm or 800 μm or so, and the θ₁ may be about 10°, 20°, 30°, 40°, 50°, 60°, 70°, 80°, 90°, 100°, 110°, 120° or so. In some instances, the area mapped may be, for instance, from 1-10 mm, 2-8 mm, 3-7 mm or 4-6 mm by 1-10 mm, 2-8 mm, 3-7 mm or 4-6 mm. In some instances, the mapping may be performed in a few seconds, such as, for instance, 30, 60, 90, 120, 150, 180, 210 or 240 seconds, a few minutes or a few hours, for instance, 2-3 hours.

In a fourth aspect, the present invention provides an article having a mark as described herein. In some embodiments, the article is an original product. The article may be, for example, a drug such as a tablet, pill or capsule. The drug may be present in a package or an envelope. The article may also be any other consumer good, such as, for example, eyeglasses, writing instruments, artwork, decorative accessories, paintings, scientific gadgets or machines, scientific apparatuses, a piece of clothing or shoes, a piece of luggage, a purse, a briefcase, a watch, an item of jewelry, a sporting device or instrument, or a limited edition of any of the foregoing or other articles.

The mark may contain one or more components, such as, for example, one or more compounds. In some embodiments, there may be one, two, three, four, five, six, seven, eight, nine, ten, twelve, fifteen, twenty, thirty or more compounds present in the mark. The one or more compounds may be substantially in a crystalline form or phase or completely in a crystalline form or phase. The presence of or position of the mark may be performed by identifying the presence, quantity, or relative quantity of one, more than one, or all of the compounds present in the mark such as, for instance, one, two, three, four, five, six, seven, eight, nine, ten, twelve, fifteen, twenty, thirty or more compounds present in the mark.

The mark may be present in an area as small as, for instance, an area having a diameter of 0.50 μm, 1 μm, 10 μm, 25 μm, 100 μm, 200 μm, 300 μm, 500 μm, 700 μm or 800 μm or so on the article. In some instances, the marker may be present on an a area of from 1-10 mm, 2-8 mm, 3-7 mm or 4-6 mm by 1-10 mm, 2-8 mm, 3-7 mm or 4-6 mm. The mark may form a substantial barcode. The barcode may be of any suitable size and may be formed of two, three, four, five, six, seven, eight, nine, ten, eleven, twelve, fifteen, twenty, thirty, forty, fifty or more bars. Each bar may be about 300 μm, 500 μm, 700 μm or 800 μm or 1 mm and about 0.50 am, 1 μm, 10 μm, 25 μm, 100 μm, 200 μm, 300 μm, 500 μm, 700 μm or 800 μm or 1 mm or so wide. Likewise, the bars may be separated by about 0.50 am, 1 μm, 10 μm, 25 μm, 100 μm, 200 μm, 300 μm, 500 μm, 700 μm or 800 μm or 1 mm or so. The mark may be made of any suitable X-ray visible compound. When present on a medicament such as a tablet, pill or capsule, the mark may be made of any FDA approved X-ray visible compound. The mark may be present on a substantially flat surface. The mark may or may not be visible by eye. Examples of suitable marks include, for instance, rutile, zinc oxide, magnesium oxide, talc and iron oxide. The mark may in some instances be present on the surface of the article, or the mark may be substantially hidden underneath a coating. The mark may in some instances be applied to the article manually using, for instance, soft lithography stamping.

### BRIEF DESCRIPTION OF THE DRAWINGS

FIG. 1 provides (A) a schematic representation of the μ-XRD configuration: (1) X-ray source, (2) collimator, (3) sample, (4) detector. θ₁ is the angle between the collimator and the sample plane and θ₂ is the angle between the sample plane and a line extending to the center of the detector. (B) a cross section of the X-ray beam at the collimator (D_{c}) and at the sample surface (for values of θ₁<90°. The length of the minor axis of the elliptical footprint, dₘᵢₙₒᵣ, is comparable to D_{c}. The length of the major axis of the elliptical footprint, dₘₐⱼₒᵣ, increases with decreasing θ₁, resulting in increased diffracted intensity but at the expense of mapping resolution. Sₑ denotes the spot size of the elliptical footprint on the sample surface.

FIG. 2 is a schematic representation of patterns created on flat surfaces or curved tablets using soft lithography stamping. (A) Barcodes comprised parallel lines with length l, width w, vertical spacings i, horizontal spacings s. (B) NYU logo defined by height h, line width w, and horizontal spacings s.

FIG. 3 provides (A) a barcode of rutile stamped on an anatase film. The barcode consisted of 3 parallel bars (labeled 1, 2 and 3), with l, w and I values as reported in Table 1. The rectangular mapping area is denoted by the dashed outline (X=11.2 mm, Y=6.5 mm). The grid point separations were Δx=0.70 mm, Δy=0.50 mm. (B) 2D μ-XRD plot. (C), (D) 3D μ-XRD plots of % crystallinity acquired with Method B across the range 26.2°≦2θ≦29.1°. Data were acquired at θ₁=θ₂=20° for 120 seconds at each grid point using the 0.30 mm diameter collimator. The sample was aligned with the barcode lines parallel to the beam. The elliptical footprint of the beam has a major axis length dₘₐⱼₒᵣ=0.88 mm. The μ-XRD plots replicated the barcode (Table 1). The total time required to map the entire grid was slightly less than seven hours.

FIG. 4 provides (A) a barcode of zinc oxide stamped on an anatase film. The barcode consisted of 3 parallel bars (labeled 1, 2 and 3), with l, w, i and s values as reported in Table 1. The rectangular mapping area is denoted by the dashed outline (X=12.5 mm, Y=5.9 mm). The grid point separations were Δx=0.40 mm, Δy=0.30 mm, (B) 2D μ-XRD plot. (C),(D) 3D μ-XRD plots of % crystallinity acquired with Method B across the range 67.5°≦2θ≦68.6°. Data were acquired at θ₁=60° and θ₂=5° for 120 seconds at each grid point using the 0.30 mm diameter collimator. The sample was aligned with the barcode lines parallel to the beam. The elliptical footprint of the beam has a major axis length dₘₐⱼₒᵣ=0.35 mm. The μ-XRD plots replicated the actual pattern (Table 1). The total time required to map the entire grid was 21 hours and 20 minutes.

FIG. 5 provides (A) a barcode of rutile stamped on an anatase film. The barcode consisted of 2 parallel bars (labeled 1 and 2), with l, w, i and s values as reported in Table 1. The rectangular mapping area is denoted by the dashed outline (X=10.9 mm, Y=3.7 mm). The grid point separations were Δx=0.50 mm, Δy=0.30 mm. (B) The same sample covered with polyethylene wrap, (C) the 2-D μ-XRD plot. (D), (E) 3-D μ-XRD plots of % crystallinity acquired with Method B across the range 68.8°≦2θ≦69.5°. Data were acquired at θ₁=60° and θ₂=5° for 300 seconds at each grid point using the 0.30 mm diameter collimator. The sample was aligned with the barcode lines parallel to the beam. The elliptical footprint of the beam has a major axis length dₘₐⱼₒᵣ=0.35 mm. The μ-XRD maps replicated the actual barcode (Table 1). The total time required to map the entire grid was almost 24 hours.

FIG. 6 depicts (A) a NYU logo of rutile stamped as a negative image on a silicon wafer. The rectangular mapping area is denoted by the dashed outline (X=15.2 mm and Y=4.2 mm). The grid point separations were Δx=0.40 mm, Δy=0.30 mm. (B) 2-D μ-XRD. (C) 3-D μ-XRD plots generated with Method A using the integrated intensity Aₚ about the peak at 69.1°. Data were acquired at θ₁=60° and θ₂=5° for 180 seconds at each grid point using the 0.30 mm diameter collimator. The sample was aligned with the logo parallel to the beam. The elliptical footprint of the beam has a major axis length dₘₐⱼₒᵣ=0.35 mm. The logo was clearly legible in the μ-XRD plots. The total time required to map the entire grid was approximately 27 hours.

FIG. 7 shows rutile barcodes on commercial ibuprofen (see Table 3 for l, w and i values) and the corresponding 2D and 3D μ-XRD plots acquired with Method B (see parameters in Table 2). The rectangular mapping areas are denoted by the dashed outlines. (A1-A4) Tablet 1; (B1-B4) Tablet 2; (C1-C4) Tablet 3 at (60°,∥); (D1-D4) Tablet 3 at (20°,∥); (E1-E4) Tablet 3 at (20°,⊥). Data acquired at 9=60° afforded higher mapping resolution than θ₁=20° and smaller w values of the barcodes, but the lower θ₂ value of 5° required for the larger θ₁ resulted in greater X-ray absorption, increasing the baseline curvature of the 3D plots in (C4) compared with (D4). The absorption effect also increased with the curvature of the tablet (E4).

FIG. 8 provides (A) a barcode of rutile (see Table 3 for l, w and i values) on commercial aspirin tablet, (B) 2-D μ-XRD, (C) and (D) 3-D μ-XRD plots acquired with Method A using the parameters in Table 2. The black rectangle depicts the area mapped with the μ-XRD and the black arrow depicts the X-ray beam direction. The x-y axis and the color-scaled bars are also depicted.

FIG. 9 shows the X-ray powder diffraction patterns of anatase (red), rutile (black) and zinc oxide (blue).

FIG. 10 provides (A) a barcode of rutile stamped on an anatase film. The barcode consisted of 3 parallel bars (labeled 1, 2 and 3), with l, w and I values as reported in Table 1. The rectangular mapping area is denoted by the dashed outline (X=11.2 mm, Y=6.5 mm). The grid point separations were Δx=0.70 mm, Δy=0.50 mm. (B) 2D μ-XRD plot. (C), (D) 3D μ-XRD plots acquired with Method A using the integrated area Aₚ for the (110) reflection at 2θ=27.5°. Data were acquired at θ₁=θ₂=20° for 120 seconds at each grid point using the 0.30 mm diameter collimator. The sample was aligned with the barcode lines parallel to the beam. The elliptical footprint of the beam has a major axis length dₘₐⱼₒᵣ=0.88 mm. The μ-XRD plots replicated the barcode (Table 1). The total time required to map the entire grid was slightly less than seven hours.

FIG. 11 provides (A) Barcode of zinc oxide stamped on an anatase film. The barcode consisted of 3 parallel bars (labeled 1, 2 and 3), with l, w, i and s values as reported in Table 1. The rectangular mapping area is denoted by the dashed outline (X=12.5 mm, Y=5.9 mm). The grid point separations were Δx=0.40 mm, Δy=0.30 mm, (B) 2D μ-XRD plot. (C),(D) 3D μ-XRD plots acquired with Method A using the integrated area Aₚ for the (2-12) reflection at 2θ=68.0°. Data were acquired at θ₁=60° and θ₂=5° for 120 seconds at each grid point using the 0.30 mm diameter collimator. The sample was aligned with the barcode lines parallel to the beam. The elliptical footprint of the beam has a major axis length dₘₐⱼₒᵣ=0.35 mm. The μ-XRD plots replicated the actual pattern (Table 1). The total time required to map the entire grid was 21 hours and 20 minutes.

FIG. 12 shows micro-XRD patterns of corundum (black) and corundum covered with 6 layers of polyethylene film with thickness=15 μm (red) collected using the 0.50 mm collimator for 10 minutes at θ₁=60° and θ₂=20°.

FIG. 13 provides (A) a barcode of rutile stamped on an anatase film. The barcode consisted of 2 parallel bars (labeled 1 and 2), with l, w, i and s values as reported in Table 1. The rectangular mapping area is denoted by the dashed outline (X=10.9 mm, Y=3.7 mm). The grid point separations were Δx=0.50 mm, Δy=0.30 mm. (B) The same sample covered with polyethylene wrap, (C) the 2-D μ-XRD plot. (D), (E) 3-D μ-XRD plots generated with Method A using the integrated area Aₚ for the (301) reflection at 2θ=69.1°. Data were acquired at θ₁=60° and θ₂=5° for 300 seconds at each grid point using the 0.30 mm diameter collimator. The sample was aligned with the barcode lines parallel to the beam. The elliptical footprint of the beam has a major axis length dₘₐⱼₒᵣ=0.35 mm. The μ-XRD maps replicated the actual barcode (Table 1). The total time required to map the entire grid was almost 24 hours.

FIG. 14 shows (A) NYU logo of rutile stamped as a negative image on a silicon wafer. The rectangular mapping area is denoted by the dashed outline (X=15.2 mm and Y=4.2 mm). The grid point separations were Δx=0.40 mm, Δy=0.30 mm. (B) 2-D μ-XRD. (C) 3-D μ-XRD plots of % crystallinity acquired with Method B across the range 68.8°≦2θ≦69.5°. Data were acquired at θ₁=60° and θ₂=5° for 180 seconds at each grid point using the 0.30 mm diameter collimator. The sample was aligned with the logo parallel to the beam. The elliptical footprint of the beam has a major axis length dₘₐⱼₒᵣ=0.35 mm. The logo was clearly legible in the μ-XRD plots. The total time required to map the entire grid was approximately 27 hours.

FIG. 15 depicts (A) the scattering intensities of a point situated on the portion of a ibuprofen tablet near to the X-ray source is partially obscured from the tablet itself and unable to reach the detector. As a result, the μ-XRD pattern relative to that point of the tablet will exhibit lower intensity (C) than other points located to the opposite side of the table closer to the detector (B) and (D) affecting the outcome of the 2D and 3D μ-XRD plots. The white arrow depicts the X-ray direction.

FIG. 16 shows rutile barcodes on commercial ibuprofen (see Table 3 for l, w and i values) and the corresponding 2D and 3D μ-XRD plots acquired with Method A (see parameters in Table 2). The rectangular mapping areas are denoted by the dashed outlines. (A1-A4) Tablet 1; (B1-B4) Tablet 2; (C1-C4) Tablet 3 at (60°,∥); (D1-D4) Tablet 3 at (20°,∥); (E1-E4) Tablet 3 at (20°,⊥). Data acquired at θ₁=60° afforded higher mapping resolution than θ₁=20° and smaller w values of the barcodes, but the lower θ₂ value of 5° required for the larger θⱼ resulted in greater X-ray absorption, increasing the baseline curvature of the 3D plots in (C4) compared with (D4). The absorption effect also increased with the curvature of the tablet (E4).

FIG. 17 shows the (A) barcode of rutile (see Table 3 for l, w and i values) on commercial aspirin tablet, (B) 2-D (C) and (D) 3-D μ-XRD plots acquired with Method B using the parameters in Table 2. The black rectangle depicts the area mapped with the μ-XRD and the black arrow depicts the X-ray beam direction. The x-y axis and the color-scaled bars are also depicted.

FIG. 18 shows commercial (A) aspirin and (B) ibuprofen tablets used for micro-XRD mapping experiments. XRD patterns of the interior (red patterns) and exterior part (black patterns) of (C) aspirin and (D) ibuprofen tablets collected at θ₁=60° and θ₂=5° for 180 seconds.

FIG. 19 provides micro-XRD patterns of corundum collected using 500 μm (black), 300 μm (red), 50 μm (blue) and 10 μm (green) diameter collimator for 1 hour at θ₁=60° and θ₂=20°.

FIG. 20 provides micro-XRD patterns of corundum (black) and corundum covered with 6 layers of polyethylene film 15 μm thick (red) collected using 500 μm collimator for 10 minutes at θ₁=60° and θ₂=20°.

FIG. 21 demonstrates (A) a zinc oxide barcode on a glass slide covered in anatase. The white rectangle depicts the area mapped with the micro-XRD. The black arrow depicts the X-ray beam direction. The diffraction patterns of (B) a grid point B on a zinc oxide bar, and (C) a grid point C on anatase. The 2-Theta range used to calculate the percent crystallinity is highlighted.

### DETAILED DESCRIPTION OF THE PREFERRED EMBODIMENTS

As used herein, the following terms have generally the following meanings:

By “article” is meant any good, manufacture or naturally occurring item. Examples include but are not limited to, a drug such as a tablet, pill or capsule, present in a package or an envelope, any consumer good, such as eyeglasses, writing instruments, artwork, decorative accessories, paintings, scientific gadgets or machines, scientific apparatuses, a piece of clothing or shoes, a piece of luggage, a purse, a briefcase, a watch, an item of jewelry, a sporting device or instrument, or a limited edition of any of the foregoing or other items.

By “mark” or “marker” is meant any suitable X-ray visible compound such as any FDA approved X-ray visible compound, whether or not visible by eye, including, for example rutile, zinc oxide, magnesium oxide, talc and iron oxide. In short, a mark or marker may be any compound or multiple compounds that may be identified by X-rays.

By “micro-diffractometer” is meant an instrument that may be used to accomplish or perform X-ray diffraction (XRD) analysis on small samples or small areas of large samples. A micro-diffractometer is particularly useful when samples are too small for the optics and accuracy of conventional diffraction instrumentation. A micro-diffractometer employs a micro X-ray beam so that diffraction characteristics can be mapped as a function of sample position. With the ability to accurately and precisely position a small X-ray beam on a sample surface, the information can be plotted as a diffraction function map (DFM). Diffraction data can contain information about compound identification, crystallite orientation (texture), stress, crystallinity, and crystallite size. One exemplary micro-diffractometer currently available is a Bruker General Area Detector Diffraction System (GADDS).

By “original article” is meant an article that is obtained from, provided by or manufactured by a known source. An original article may be a member of a known or identified batch, order, or assembly. In contrast, a “counterfeit article” or a “copy” is meant to encompass an article that is not obtained from, not provided by or not manufactured by a known source. As such, a counterfeit article” or a “copy” is not a member of an identified or known batch, order, or assembly.

By “analyzing the presence of or the position of the mark on the article” may include generating a diffraction pattern using, for instance, a micro-diffractometer. The presence of or position of the mark may be analyzed or identified with respect to one-dimension or two-dimensions. The presence of or position of the mark may be identified using, for instance, an x-ray micro-diffractometer. The mark may contain one or more components, such as, for example, one or more compounds. In some embodiments, there may be one, two, three, four, five, six, seven, eight, nine, ten, twelve, fifteen, twenty, thirty or more compounds present in the mark. The one or more compounds may be substantially in a crystalline form or phase or completely in a crystalline form or phase. Likewise, analyzing the presence of or position of the mark may be performed by identifying the presence, quantity, or relative quantity of one, more than one, or all of the compounds present in the mark such as, for instance, one, two, three, four, five, six, seven, eight, nine, ten, twelve, fifteen, twenty, thirty or more compounds present in the mark. Similarly, analyzing the presence of or position of the mark may be performed by identifying the presence, quantity, or relative quantity of one or more peaks generated by diffraction analysis.

The present invention provides X-ray diffraction methods useful for identifying articles, useful for identifying counterfeit articles, and useful for distinguishing original articles from counterfeit articles. The methods may use a micro-diffractometer that may be equipped with one or more collimators that enable acquiring diffraction patterns on sample areas as small as, for instance, 300 μm. Common XRPD analysis requires the whole diffraction patterns for phase identification, but the methods of the present invention may use only a few, for instance one, selected peaks to map X-ray visible patterns such as those made of compounds. As such, the methods of the present invention are relatively user friendly. The methods of the present invention are relatively fast, not destructive to the articles identified, substantially completely automated, and may be applied on packages and articles such as drugs to certify their authenticity. Moreover, there are a limited number of manufactured micro-diffractometers presently available. This makes such instruments easy to track. As such, the methods of the present invention provide a useful tool for tracking and identifying counterfeit articles and counterfeiters.

Many materials and compounds are suitable as a marker for the methods described herein. Markers may be suitable metals, salts of metals, metal complexes, pigments based on metal complexes and/or metal salts, silicon oxides, like SiO₂, silicates, aluminates as well as other materials and compounds known to absorb or reflect x-rays. An article may be marked with such a marker or such a marker may be intrinsic to or internal in an article. Examples of suitable markers include pigments in coatings or colors, such as those present on an envelope, or a guide such as patient information, operating instructions, or a warranty. The methods take advantage of the fact that counterfeiters do not know the accurate composition of the marker. The marker may be recognized or detected in a one-dimensional or two-dimensional recognition. An x and y coordinate system may be used to produce a picture of the markers. The methods may then be used to determine whether the number of marks and their spatial arrangement correspond to those of the original products. If marks are missing or are not arranged properly in x and y coordinates, then the article may be identified as an imitation article or counterfeit. A marker may be provided in a coating of an article, in a bar code, or in or on the packaging, such as, for instance, an aluminum blister pack, a plastic package or a cardboard or paper container or wrap. The mark may not be visible to the naked or unaided eye in many instances. Rather, it may be visible only via X-ray.

In some instances, the mark may be an intrinsic mark that is present or substantially already present in the article. Such an intrinsic mark may be, for instance, normally used ink present on a package such as a blister or accompanying documentation. The ink may differ from that of counterfeit products and thus identifiable. The mark may contain substances or compounds that may be recognized by the methods described herein because they divert x-ray radiation differently, e.g. stronger, than typically used substances or compounds. Examples include, for instance, a metalliferous color, ink on a sticking box, tantalum containing ink on a SmPC. In some instances, the mark may contain a metal, such as a rare earth metal, or those found in the periodic table of elements in, for instance, groups Ha, IIIb, IVb, Vb, VIb, VIIb, VIIIb, Ib, IIb, IIIa, Va, and VIIa. The mark may be a salt, complex, pigment or composite material comprising at least one of these metals or elements. Examples include salts, complexes, and pigments containing tantalum or samarium, silicon oxides, like siloxanes and SiO₂ based or aluminum containing paper coatings. Further examples include metals, siloxanes, SiO₂ containing compounds, aluminum containing compounds, glass and silicates, and paper, paperboard, plastics, hydrocarbons, paraffins, ceramic etc. The mark may contain a chemical element such as, for instance, a metalloid or a metal, e.g. silicon, tantalum, neodymium, cerium, lanthanum, gadolinium and samarium or silanes or silicones.

The methods described herein may be automated. Using the micro-diffractometers, at least one and two-dimensional, automated studies of original articles and counterfeit articles may be performed in parallel. Individual articles, whole containers, cardboard boxes, etc. may be scanned in one or two dimensions and displayed in x, y coordinates thereby providing a picture. Alterations in marks in the x, y coordinates compared to the marks in the original articles may then be used to identify counterfeit articles.

The methods described herein may be used to supply an individualized marking for a particular article, batch, series of articles or group of articles.

A micro-X-ray diffraction mapping method was developed and tested on different substrates. The method was able to map barcodes made of FDA approved and X-ray visible compounds on flat surfaces and on commercial tablets, even when the mark was hidden with polyethylene films and not visible by eye. Rutile and zinc oxide were used for the marks, however, other compounds such as, for instance, magnesium oxide, talc and iron oxide may be used. The resolution of the X-ray beam depends on the θ₁ angle and the diameter of the collimator D_{c}. The mapping resolution in these methods was 300 μm, and it was achieved at D_{c}=300 μm and θ₁=60° with an increment at the same time of the background effect in curved surfaces. Mapping smaller areas reduces simultaneously the background effect and the time of the experiment. Areas of 3 mm×2 mm can be mapped in 2-3 hours at a resolution of 300 μm. Since the x-ray beam penetrates easily the tablet coatings, the method can be used to identify marks hidden underneath the coating to certify the authenticity of a drug without any sample preparation or dissolution. These procedures are completely automated, easy to use also for not experienced employees and, moreover, the limited number of micro-diffractometers makes this method a useful tool to track counterfeit sources.

The following examples are purely illustrative of the invention are not to be construed as limiting.

### Example 1

### Materials

Rutile, anatase and zinc oxide (Sigma-Aldrich, St. Louis, Mo., USA) were purchased and used as obtained without further purification. Light corn syrup was purchased from ACH Food Companies Inc., Memphis, Tenn., USA. Coated 325 mg aspirin tablets were purchased from CVS Pharmacy Inc., Woonsocket, R.I., USA. Coated 200 mg ibuprofen tablets were purchased from DuaneReade, New York, N.Y., USA. Glistening metallic spray paint was purchased from Krylon Products Group, Cleveland, Ohio, USA. Sylgard® 184 Poly dimethyl siloxane (PDMS) and Sylgard® 184 silicone elastomer curing agent were purchased from Dow Corning Corporation, Midland, Mich., USA. Glass microscope slides were purchased from Fisher Scientific, Pittsburgh, Pa., USA. Silicon wafers (100) were purchased from Universitywafer, South Boston, Mass., USA. Polyethylene film was purchased from The Glad Products Company, Oakland, Calif., USA. Plastic masks for photolithography were obtained from CAD Art Services Inc., Bandon, Oreg., USA.

Stamp Preparation.

PDMS elastomer stamps were fabricated using conventional methods. (Declaration of Rome, Conclusions and Recommendations of the WHO International Conference on Combating Counterfeit Medicines, 18 Feb., 2006). A layer of SU-8 negative photoresist was spin-coated onto silicon wafers and exposed to UV light (365 nm) for 45 seconds through a plastic mask with transparent features corresponding to the desired stamp master. The removal of the unexposed non-polymerized photoresist was performed by dipping the silicon wafer into a 1-methoxy-2-propyl acetate developing solution for six minutes, thereby producing the desired stamp master features on the wafer surface. PDMS stamps were prepared using these silicon surfaces as master molds. PDMS was first thoroughly mixed with the curing agent (at a 10:1 w/w ratio) and allowed to stand under vacuum for 30 minutes at room temperature to allow escape of air bubbles from the mixture. The stamp was then fabricated by pouring the mixed elastomer into the silicon master mold, cured in an oven at 120° C. for 5 hours, and peeled from the master mold, thereby producing a negative pattern of the master.

Printing Patterns on Flat Substrates.

Formulations for barcodes and the logos consisted of suspensions of rutile powder mixed with corn syrup in a 1:2.5 w/w ratio or zinc oxide powder mixed with corn syrup at a 1:10 w/w ratio. These compositions afforded stable suspensions. PDMS stamps fabricated with a particular barcode or logo were inked by gently pressing the stamp onto a thin layer of the suspension, and the pattern was transferred to a flat substrate by contacting the stamp with slight pressure. Barcodes were stamped onto glass slides that were previously covered with a layer of a 1:4 w/w anatase:corn syrup suspension. Anatase, which has high scattering intensities and is commonly found in tablet coatings, was applied as a thin film to evaluate the potential interference of this crystalline material (i.e., from its XRD peaks) in a pharmaceutical formulation during μ-XRD mapping of barcodes. The white anatase film was coated with spray paint prior to transfer of the pattern so that the pattern could be distinguished visually (rutile and zinc oxide also are white), which was needed to verify transfer and fidelity of the pattern for the purpose of validating the protocol. Spray paint proved convenient for this purpose because it could be applied homogeneously. In one trial, the barcodes were then covered with a polyethylene film followed by a coating of spray paint, which completely obscured the barcodes. This final step was performed to mimic a tablet coating that would make the barcode invisible to the naked eye while testing the impact of X-ray absorption by a coating material. The mass absorption coefficient of polyethylene was determined by measurements of the diffraction intensity from a corundum standard (NIST 1976a) covered with polyethylene. Corundum was covered with 1-6 polyethylene sheets, each 15 μm thick, and the diffraction intensity was acquired for 10 minutes (ranging 15-90 μm) (12). The intensities of the peak of corundum at 2θ=76.9° were compared, and for polyethylene, p=0.94 g/cm³ and, at 2=1.54178 A, and Iₓ/I₀=0.92, the μ=50.8 cm²/g. The Iₓ of the X-ray beam was 92% after it passed through coating thickness ct=90 μm (Supporting Information).

The NYU logo was stamped as a negative image onto a 1 cm×2.5 cm rectangular surface of bare silicon wafer. Silicon wafers were used to evaluate an alternative substrate. Silicon wafers somewhat reduced the spreading of the suspension during stamping, affording a slight improvement in feature quality. The {100} silicon diffraction peaks did not interfere with logo mapping because Bragg scattering from these planes occurred at a 2θ value different than the incident angles chosen for mapping (see below). The printed barcodes and logos were inspected under an optical microscope and mounted on the sample holder of the microdiffractometer.

Stamping Barcodes on Tablets.

A PDMS stamp with a barcode pattern was inked with the 1:2.5 w/w rutile:corn syrup suspension as described above. The barcode was then transferred to commercially obtained tablets of aspirin and ibuprofen. The printed barcodes were inspected under optical microscope and mounted on the sample holder of the microdiffractometer.

μ-XRD Experiments.

X-ray data were collected on a Bruker D8 DISCOVER General Area Detector Diffraction System (GADDS) equipped with a VANTEC-2000 area detector and a centric Eulerian cradle that permitted the automatic alignment of the sample in the x-y-z axes using a laser-video sample alignment system. The X-ray generated from a sealed Cu tube was monochromated by a graphite crystal and collimated by 0.50 mm or 0.30 mm MONOCAPS (λ Cu-Kα=1.54178 Å). The sample-to-detector distance was fixed at 150 mm and the angles θ₁ and θ₂ were adjusted as needed (see below). A mapping grid of x-y coordinates was programmed into the GADDS software, which controls the position of the sample stage in the x-y plane. Data were collected at each grid for a preassigned time and processed by the Bruker GADDS software. (Declaration of Rome, Conclusions and Recommendations of the WHO International Conference on Combating Counterfeit Medicines, 18 Feb., 2006). The z-height of the sample stage was maintained constant at each grid point for flat samples (glass slides and silicon wafers) but was changed automatically by the laser-video sample alignment system for curved samples (tablets) in order to maintain a fixed distance between the collimator and the sample surface.

μ-XRD Mapping.

Two methods (A and B) were used to process the data for construction of μ-XRD maps. Method A relied on the integration of the total diffraction intensity, using the Bruker GADDS software, (GADDSMap (version 1.1.05). Program for Bruker General Area Detector Diffraction System. Bruker AXS Inc., Madison, Wis., 2004) for a specific (hkl) plane on the 2D detector collected for an equivalent time on each grid point. A 2D plot of integrated intensity (Aₚ) for each grid point, which corresponds the area under a diffraction peak in a 1D diffraction pattern, was constructed using color coding to represent different Aₚ values. 3-D plots of the intensities in the x-y plane also were generated using the GADDSMap software (Declaration of Rome, Conclusions and Recommendations of the WHO International Conference on Combating Counterfeit Medicines, 18 Feb., 2006). In order to account for the possibility of background scattering, including scattering from amorphous phases, Method B relied on the integration of the intensity over a 2θ range larger than that bracketing the selected (hkl) plane at each grid point. The percent crystallinity (% crystallinity) was calculated at each grid point using the Bruker GADDS software (GADDSMap (version 1.1.05). Program for Bruker General Area Detector Diffraction System. Broker AXS Inc., Madison, Wis., 2004) and eq. (1), wherein Aₚ is the integrated intensity spanning the selected (hkl) reflection and A_{b} is the integrated intensity for the entire 2θ range. 2D plots were constructed using color coding to represent % crystallinity at each point, and 3-D plots of % crystallinity were generated using the GADDSMap software.

$$\% crystallinity = \frac{{A}_{p}}{{A}_{p} + {A}_{b}} \times 100 \qquad ( 1 )$$

### Results and Discussion

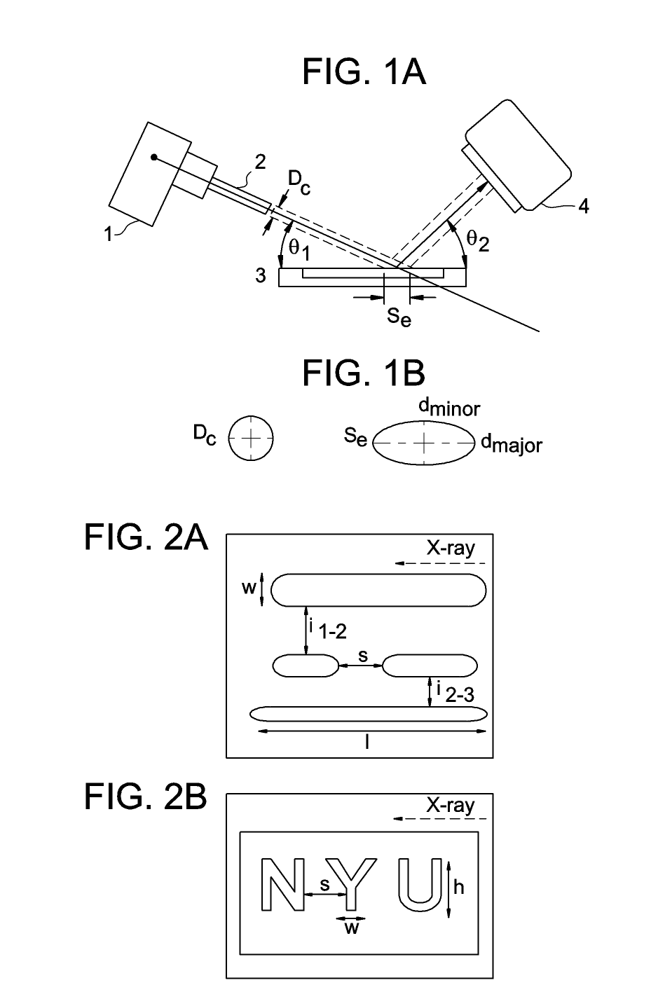

The μ-XRD system used for the development of the mapping protocol was a Broker General Area Detector Diffraction System (GADDS) equipped with a centric Eulerian cradle that permitted the automatic alignment of the sample in the x-y-z axes using a laser-video sample alignment system. The system was equipped with collimators having a diameter (D_{c}) of either 0.30 mm or 0.50 mm and a 2D VANTEC area detector that permitted rapid data collection (FIG. 1A). The 0.50 mm collimator afforded greater diffraction intensity but at the expense of mapping resolution, which is defined as the minimum separation between two parallel lines of a stamped pattern that can be resolved by the X-ray beam. Nonetheless, both collimator sizes enabled facile spatial mapping of patterns, either barcodes or logos, created by soft lithography stamping. Mapping is performed at a fixed angle of incidence θ₁ between the collimator and the sample. The X-ray spot size on the sample (Sₑ) is larger than D_{c} because θ₁ is oblique, creating an elliptical footprint on the sample surface for any value of 0°<θ₁<90° (FIG. 1B). The length of the minor axis of the elliptical footprint, dₘᵢₙₒᵣ, is comparable to D_{c}, but the length of the major axis, dₘₐⱼₒᵣ, increases with decreasing θ₁. For a given data collection time, the diffraction intensity will increase with decreasing θ₁ due to the increased interrogated area, but at the expense of mapping resolution, accordingly to eq. (2). Conversely, increasing θ₁ will increase the mapping resolution, but as θ₁ is increased the detector must be moved to small values of θ₂ (the angle between the sample and a line extending to the center of the detector) in order to capture the desired (hkl) reflection at its Bragg angle, 2θ, on the detector. The upper instrumental limit for θ₁ is 60°, and θ₂ cannot be less than 2° practical reasons as a large area of the detector will be obscured by the sample stage.

$${d}_{major} = \frac{{D}_{c}}{sin {θ}_{1}} \qquad ( 2 )$$

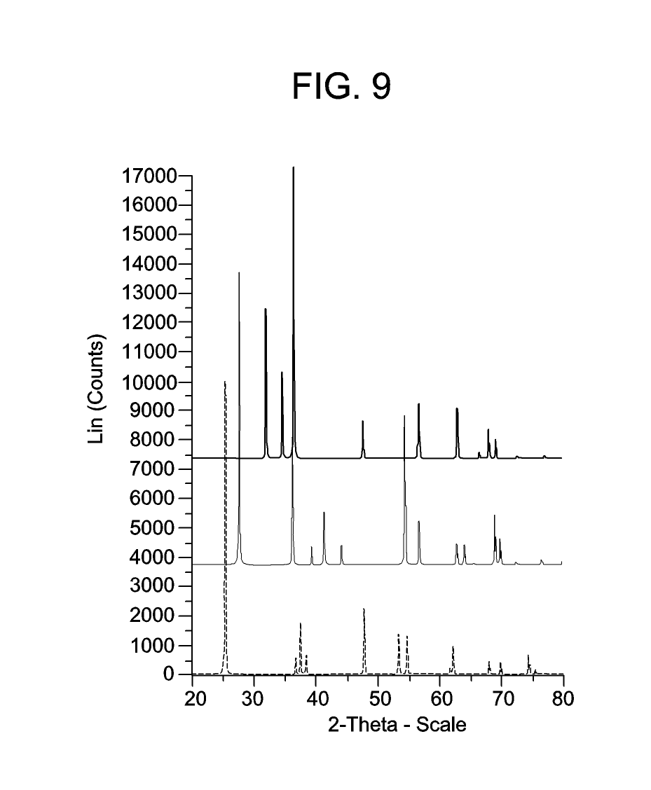

Drug tagging requires that the substance used to create a defining pattern on a tablet is approved by the Food and Drug Administration (FDA). Most APIs exhibit strong diffraction peaks at low Bragg angle; therefore, a fast and reliable readout will be best achieved if the pattern material has high diffraction intensity for at least one peak at a large θ₁ value that is not obscured by the API. In the case of μ-XRD, the best resolution will be obtained at larger values of θ₁ but the smaller elliptical footprint reduces the measured intensity. This argues for pattern substances with high scattering intensities (i.e., high Z). Zinc oxide (hexagonal space group P6₃mc, a=b=3.25 Å, c=5.21 Å, α=β=90°, γ=120°) and the rutile form of titanium dioxide (tetragonal space group P42/mnm, a=b=4.59 Å, c=2.96 Å, α=β=γ=90°) were selected as pattern materials (FIG. 9). μ-XRD mapping of the patterns on flat surfaces and commercial tablets of aspirin and ibuprofen was performed by measuring the diffraction intensities across the x-y plane, using 2θ=68.0° for zinc oxide (corresponding to (2-12) and 2B=27.5° and 69.1° for rutile (corresponding to (110) and (301), respectively). The zinc oxide (2-12) reflection was selected because it allowed the use of larger θ₁ values, thereby decreasing the beam footprint and increasing the mapping resolution. The (301) reflection of rutile was selected for the same reason. The (110) of rutile was chosen for its high intensity, but it required a smaller θ₁ value accompanied by a larger footprint and reduced mapping resolution. This collection of variables enabled examination of the most important parameters for optimization of the protocol. The uppermost 2θ values aspirin and ibuprofen are 2θ=33° (213) and 35° (123), respectively. Zinc oxide appears on the FDA Generally Recognized As Safe (GRAS) list, and it is commonly used in dietary supplements. (Declaration of Rome, Conclusions and Recommendations of the WHO International Conference on Combating Counterfeit Medicines, 18 Feb., 2006; Combating Counterfeit Drugs: A Concept Paper for Effective International Cooperation, World Health Organization, Health Technology and Pharmaceuticals, WHO, 27 Jan., 2006). Both rutile and anatase forms of titanium dioxide are approved by the FDA as a colorant in drugs and food, (Declaration of Rome, Conclusions and Recommendations of the WHO International Conference on Combating Counterfeit Medicines, 18 Feb., 2006) although anatase is more commonly used. Although the anatase form exhibits large scattering intensities and could be used as a pattern material, it was not included in this investigation because of the potential interference of anatase excipients in many commercial formulations.

The patterns were prepared using PDMS stamps that had been inked with a suspension of the selected compounds in commercial corn syrup, a safe and cheap medium. This approach is simple and produces patterns adequate for proof-of-principle. The patterns used were barcodes and “NYU” logos, the latter mimicking a trademark that may be used by an authorized manufacturer of a genuine product. (FIG. 2). The barcodes were stamped as positive images, comprising parallel lines with length l, width w, vertical spacings i, and horizontal spacings s (FIG. 2A). The letters of the “NYU” logo were created as a negative image, with a height h, line width w, and horizontal edge-to-edge spacing s; the ultimate resolution is defined by the width w (FIG. 2B). Slight non-uniformities in w and i were observed within each pattern because of the inherent non-uniform pressure applied to the stamps during the printing. The samples were aligned with the barcode lines parallel to the X-ray beam during mapping so that the minor axis of the elliptical footprint of the X-ray beam was perpendicular to the lines, thus providing maximum resolution. In the case of the barcodes the elliptical footprint results in an artificially larger value of l. The ability to resolve the lines of the bar code is determined by d_{c} and i; for best results i should be comparable or greater than d_{c}. The line widths will be more accurate when w>dₘᵢₙₒᵣ. In the case of the logos, stamped as negative images, the ability to resolve the features will improve as w and s increases, with the best resolution obtained when both are larger that dₘₐⱼₒᵣ.

Readout of the barcodes and logos required programming of a mapping grid, based on x-y coordinates that determines the grid points at which X-ray diffraction intensity was measured. The minimum horizontal (Δx) and vertical (Δy) spacings between two consecutive grid points were selected to optimize mapping time and detection of all features in the barcode or logo. The time (7) required to acquire a 2D intensity map of the entire surface depends on the number of grid points (n_{gp}) and the collection time at each grid point (t) (eq. 3). Larger values of Δx and Δy values reduce T, but also risks incomplete mapping of the pattern features. The z-height of the sample stage was maintained constant at each grid point for flat samples (glass slides and silicon wafers) but was changed automatically by a laser-video sample alignment system for curved samples (tablets) in order to maintain a fixed distance between the collimator and the sample surface.

T=n_{gp}t (3)

Two methods (A and B) were used to process the data for construction of μ-XRD maps. Method A relied on the integration of the total diffraction intensity, using the Bruker GADDS software, (GADDSMap (version 1.1.05). Program for Bruker General Area Detector Diffraction System. Bruker AXS Inc., Madison, Wis., 2004) for a specific (hkl) plane on the 2D detector collected for an equivalent time on each grid point. A 2D plot of integrated intensity (Aₚ) for each grid point, which corresponds the area under a diffraction peak in a 1-D diffraction pattern, was constructed using color-coding to represent different Aₚ values. 3D plots of the intensities in the x-y plane also were generated using the GADDSMap software (Declaration of Rome, Conclusions and Recommendations of the WHO International Conference on Combating Counterfeit Medicines, 18 Feb., 2006). In order to account for the possibility of background scattering, including scattering from amorphous phases, Method B relied on the integration of the intensity over a 2θ range larger than that bracketing the selected (hkl) plane at each grid point. The percent crystallinity (% crystallinity) was calculated at each grid point using the Bruker GADDS software (GADDSMap (version 1.1.05). Program for Bruker General Area Detector Diffraction System. Bruker AXS Inc., Madison, Wis., 2004) and eq. (1), wherein Aₚ is the integrated intensity spanning the selected (hkl) reflection and A_{b} is the integrated intensity for the entire 2θ range. 2D plots were constructed using color coding to represent % crystallinity at each point, and 3D plots of % crystallinity were generated using the GADDSMap software. Both methods produced similar μ-XRD maps for patterns on flat substrates. Method A produced μ-XRD maps with somewhat better pattern fidelity than method B for aspirin, whereas only method B gave satisfactory results for ibuprofen. Although the reason for the failure of method A with ibuprofen is not well understood at this stage, it may reflect differences in the composition and shape of the aspirin and ibuprofen tablets (aspirin tablets have a higher radius of curvature), which would be expected to affect scattering.

Rutile Patterns on Anatase Films.

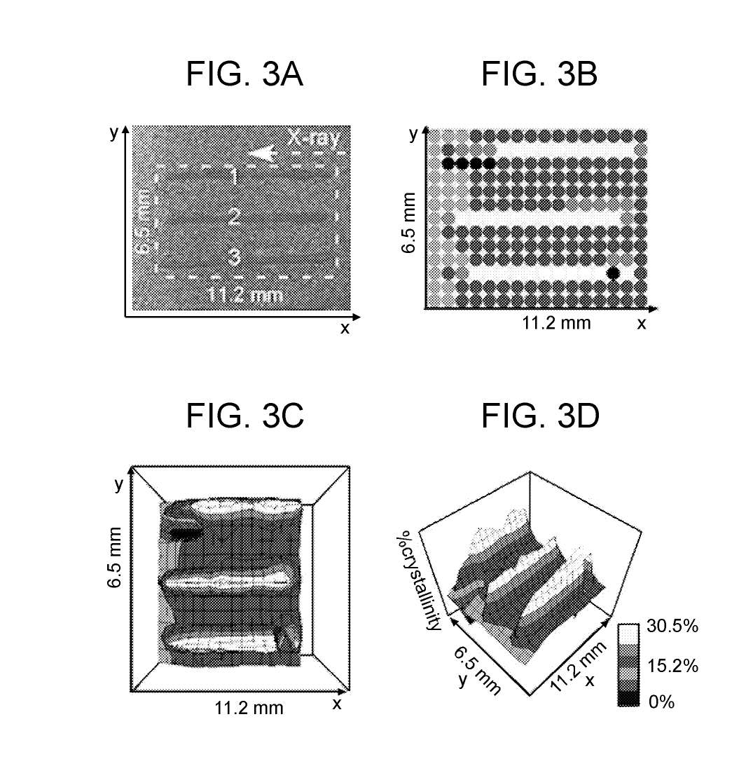

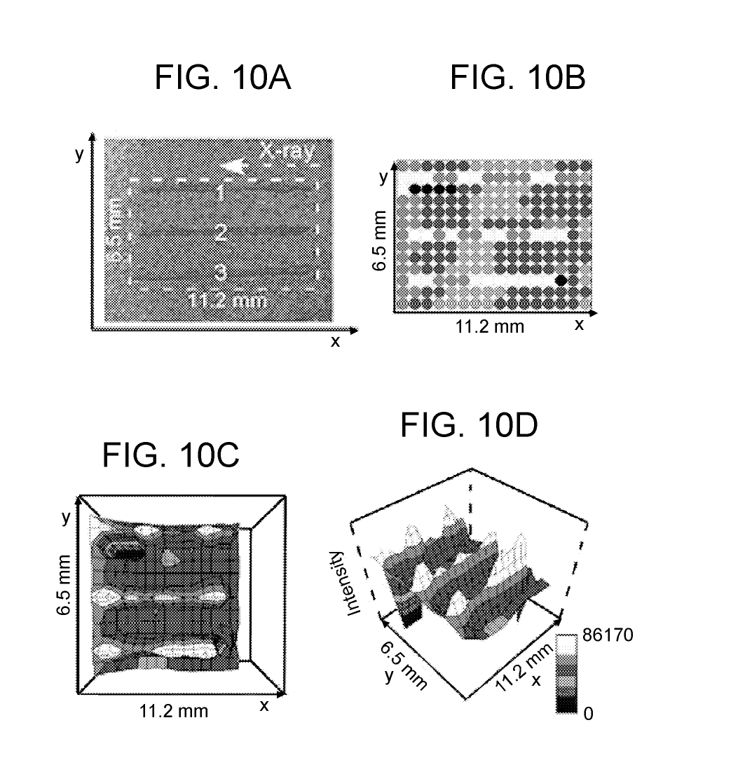

The μ-XRD mapping method can be illustrated for a rutile barcode printed on a glass slide covered previously coated with anatase (FIG. 3A). Anatase, which has high scattering intensities and is commonly found in tablet coatings, was applied as a thin film to evaluate the potential interference of this crystalline material (i.e., from its XRD peaks) in a pharmaceutical formulation during μ-XRD mapping of barcodes. The white anatase film was coated with spray paint prior to transfer of the pattern so that the pattern could be distinguished visually (rutile also is white), as needed to verify transfer and fidelity of the pattern for the purpose of validating the protocol. Spray paint is convenient for this purpose because it may be applied homogeneously. In one example, the barcode consisted of 3 parallel lines (labeled 1, 2 and 3 in FIG. 3A), with l₁=9.50 mm, l₂=9.40 mm, l₃=9.50 mm, 1.70 mm≦i₁₋₂≦2.0 mm, 1.50 mm≦i₂₋₃≦1.80 mm, 0.30 mm≦w₁≦0.40 mm, 0.33 mm≦w₂≦0.43 mm, and 0.25 mm≦w₃≦0.45 mm (i and w are described by ranges due to the inherent non-uniformity during stamping). A mapping grid was programmed for a rectangular area with dimensions X=11.2 mm and Y=6.5 mm, with grid points at intervals of Δx=0.70 mm and Δy=0.50 mm (FIG. 3A). Data were acquired at θ₁=θ₂=20° for 120 seconds at each grid point using the 0.30 mm diameter collimator, which afforded dₘₐⱼₒᵣ=0.88 mm. The total time required to map the entire grid was slightly less than seven hours. Method A was used to construct 2D and 3D plots of Aₚ for the (110) reflection at 2θ=27.5°, whereas method B was used to create plots of % crystallinity over the range 26.2°≦2θ≦29.1° (FIGS. 3C-D). A typical μ-XRD map of the aforementioned barcode using Method B revealed 3 parallel lines with l₁=10.5 mm (equivalent to 15 grid points), l₂=l₃=9.8 mm (14 grid points), w₁=w₂=w₃=0.50 mm (1 grid point), 1.5 mm≦i₁₋₂≦2.0 mm (3-4 grid points) and 1.0 mm≦i₂₋₃≦1.5 mm (2-3 grid points). The μ-XRD maps obtained using method A afforded similar results (FIG. 10). The l values determined from the μ-XRD maps were somewhat larger than the actual l values of the barcode (for example, l₁(map)=10.5 mm; l₁(actual)=9.5 mm) because of the elliptical footprint of the X-ray beam (dₘₐⱼₒᵣ877 μm at θ₁=20°) of the X-ray beam. As expected, the widths of the lines revealed by the map were identical because Δy was slightly larger than the actual widths. The i values were replicated faithfully.

TABLE 1
Comparision of l, w, i and s (mm) for actual and mapped barcodes
stamped on flat surfaces.

| | | | | | | Rutile on^{c} | |
|---|---|---|---|---|---|---|---|
| | | Rutile^{a} | | Zinc oxide^{b} | | anatase | |
| Pa- | | on | | on | | polyethylene | |
| ram- | Pattern | Anatase | | Anatase | | wrap | |
| eter | Type | A | B | A | B | A | B |
| l₁ | Actual | 9.5 | 9.5 | 10.0 | 10.0 | 9.6 | 9.6 |
| | Map | 10.5 | 10.5 | 9.6 | 9.6 | 9.5 | 9.5 |
| l₂ | Actual | 9.4 | 9.4 | 8.8 | 8.8 | 9.2 | 9.2 |
| | Map | 9.8 | 9.8 | 8.8 | 8.8 | 9.0 | 9.0 |
| l₃ | Actual | 9.5 | 9.5 | 10.8 | 10.8 | — | — |
| | Map | 9.8 | 9.8 | 10.8 | 10.8 | — | — |
| w₁ | Actual | 0.3-0.4 | 0.3-0.4 | 0.3-0.6 | 0.3-0.6 | 0.4-0.5 | 0.4-0.5 |
| | Map | 0.5 | 0.5 | 0.3-0.6 | 0.3-0.6 | 0.3-0.6 | 0.3-0.6 |
| w₂ | Actual | 0.3-0.4 | 0.3-0.4 | 0.2-0.4 | 0.2-0.4 | 0.4-0.5 | 0.4-.05 |
| | Map | 0.5 | 0.5 | 0.3-0.6 | 0.3-0.6 | 0.3-0.6 | 0.3-0.6 |
| w₃ | Actual | 0.3-0.4 | 0.3-0.5 | 0.4-0.5 | 0.4-0.5 | — | — |
| | Map | 0.5 | 0.5 | 0.3-0.9 | 0.3-0.9 | — | — |
| i₁₋₂ | Actual | 1.7-2.0 | 1.7-2.0 | 1.9 | 1.9 | 1.7-1.8 | 1.7-1.8 |
| | Map | 1.5-2.0 | 1.5-2.0 | 1.8 | 1.8 | 1.5-1.8 | 1.5-1.8 |
| i₂₋₃ | Actual | 1.5-1.8 | 1.5-1.8 | 1.4-1.8 | 1.4-1.8 | — | — |
| | Map | 1.0-1.5 | 1.0-1.5 | 1.2-1.8 | 1.2-1.8 | — | — |
| s₁ | Actual | — | — | — | — | 0.3 | 0.3 |
| | Map | — | — | — | — | 0.3 | 0.3 |
| s₂ | Actual | — | — | 1.8 | 1.8 | — | — |
| | Map | — | — | 1.6 | 1.6 | — | — |
| s₃ | Actual | — | — | 0.7 | 0.7 | — | — |
| | Map | — | | 0.8 | 0.8 | — | — |

^{a}θ₁ = θ₂ = 20° for 120 seconds at each grid point; the 0.30 mm diameter collimator (dₘₐⱼₒᵣ = 0.88 mm).
^{b}θ₁ = 60° and θ₂ = 5° for 120 seconds at each grid point; 0.30 mm diameter collimator (dₘₐⱼₒᵣ = 0.35 mm).
^{c}θ₁ = 60° and θ₂ = 5° for 300 seconds at each grid point; 0.30 mm diameter collimator (dₘₐⱼₒᵣ = 0.35 mm).

Zinc Oxide Patterns on Anatase Films.

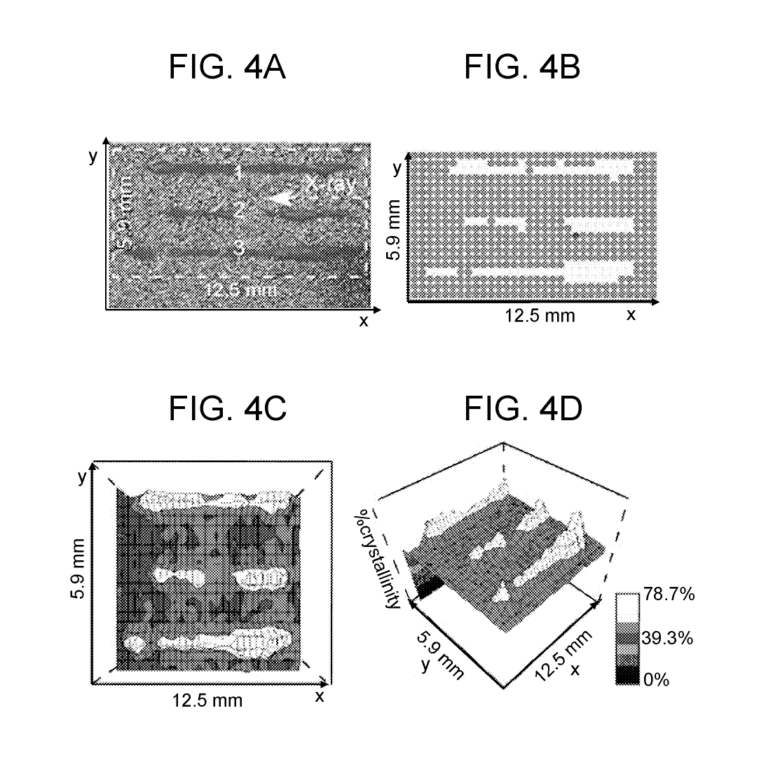

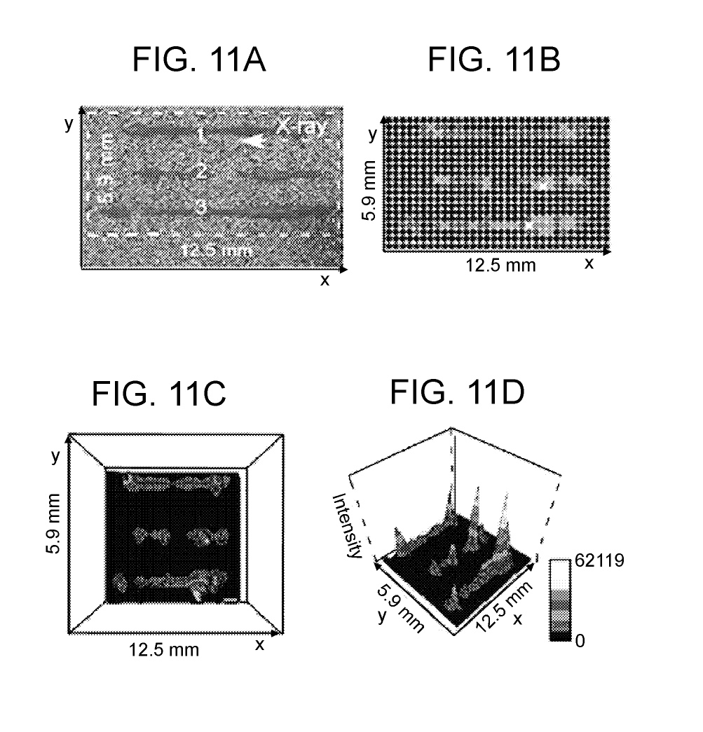

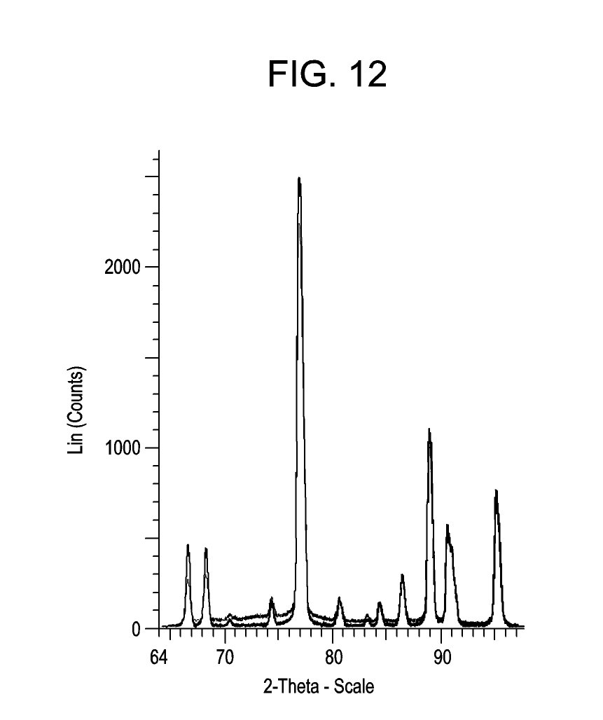

μ-XRD mapping of a barcode of zinc oxide printed on a glass slide covered in anatase demonstrated that the protocol could be extended to other pattern materials that exhibits sufficient diffraction intensity for at least one (hkl) reflection. Using a barcode (Table 1) different than the one described above for rutile, μ-XRD maps were acquired using either method A or B and the (2-12) reflection at 2θ=68.0° (% crystallinity was measured over the range 67.5°≦2θ≦68.6° for method B). The instrument settings were θ₁=60° and θ₂=5°, and a rectangular mapping grid with dimensions X=12.5 mm and Y=5.9 mm with Δx=0.40 mm and Δy=0.30 mm and the 0.30 m diameter collimator were used (FIG. 4A). The large θ₁ afforded a small footprint, dₘₐⱼₒᵣ=0.35 mm, which translates to the highest resolution attainable for this collimator. The total time required for mapping the barcode was 21 hours and 20 minutes. The μ-XRD maps were faithful replicas of the actual pattern (Table 1, FIGS. 4, 11).

Rutile Pattern on Anatase Films with Polyethylene Wrap.

In order to protect an identification pattern while rendering the code invisible to the naked eye, anti-counterfeit measures based on μ-XRD mapping would likely bury the pattern beneath a tablet coating, which typically range from 40 μm to 100 μm in thickness. The measured diffraction intensity from the buried pattern would be reduced by absorption of the X-ray beam by the coating according to eq. (3), wherein Iₓ is the intensity of the diffracted beam after passing through a coating with thickness ct, I₀ is the incident X-ray beam intensity, μ is the mass absorption coefficient, and p is the coating density. The mass absorption coefficient depends on the X-ray the substance and the wavelength, which in this investigation is λ_{CuKα}=1.54178 Å. In the μ-XRD configuration used herein, the effective thickness of the coating ct is given by eq. (4).

$$\begin{matrix}{I}_{x} = {I}_{0} {e}^{- μρ d} & ( 3 ) \\ ct = - {ln ( 1 - \frac{{I}_{x}}{{I}_{0}} ) [ μ ρ ( \frac{1}{sin {θ}_{1}} + \frac{1}{sin ( 2 θ - {θ}_{1} )} ) ]}^{- 1} & ( 4 )\end{matrix}$$

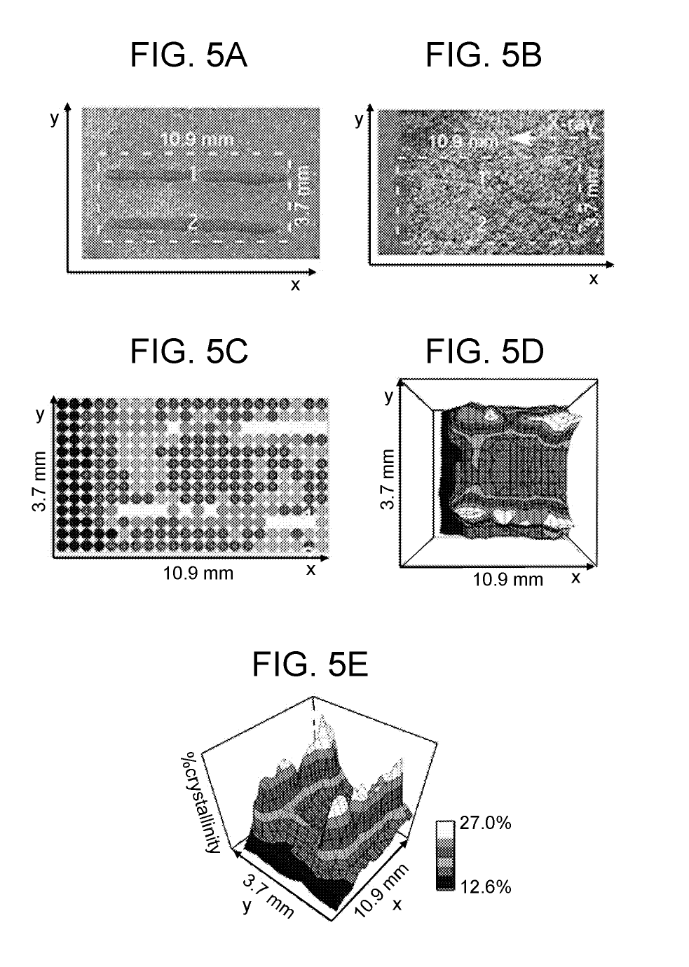

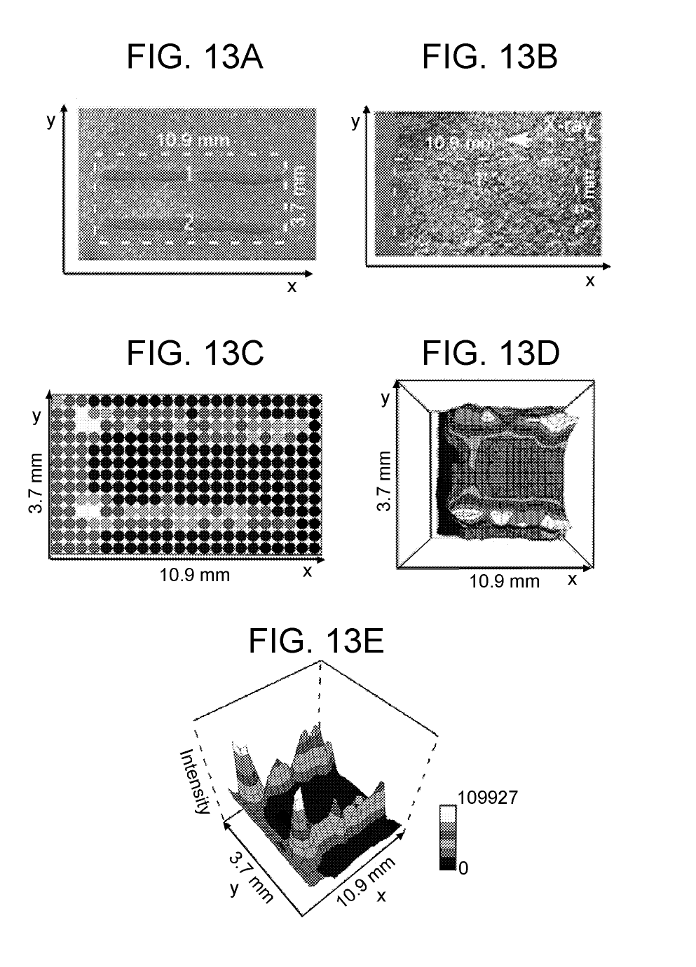

A tablet coating was simulated by placing three 15 μm thick polyethylene sheets over a rutile barcode that had been stamped onto an anatase film on a glass slide. The mass absorption coefficient was determined to be 50.8 cm²/g (see above). The X-ray beam is attenuated to 92% of the incident intensity for a 45 μm-thick film (the polyethylene film was covered with spray paint to hide the barcode, FIG. 5). The barcode consisted of 2 parallel lines, denoted 1 and 2 (FIG. 5, Table 1). μ-XRD maps were acquired using either method A or B and the (301) reflection at 2θ=69.1° (% crystallinity was measured over the range 68.8°≦2θ≦69.5° for method B). Data were acquired for 300 seconds at each grid point using the 0.30 mm collimater and θ₁=60° and θ₂=5°. The mapping grid was rectangular with dimensions of 10.9 mm×3.7 mm, with Δx=0.50 mm and Δy=0.30 mm. The large θ₁ afforded a small footprint, dₘₐⱼₒᵣ=0.35 mm, the highest resolution attainable for this collimator. The total time required to map the barcode was approximately 24 hours. The μ-XRD maps were faithful replicas of the actual pattern (Table 1, FIGS. 5, 13).

Rutile Logo on a Silicon Wafer.

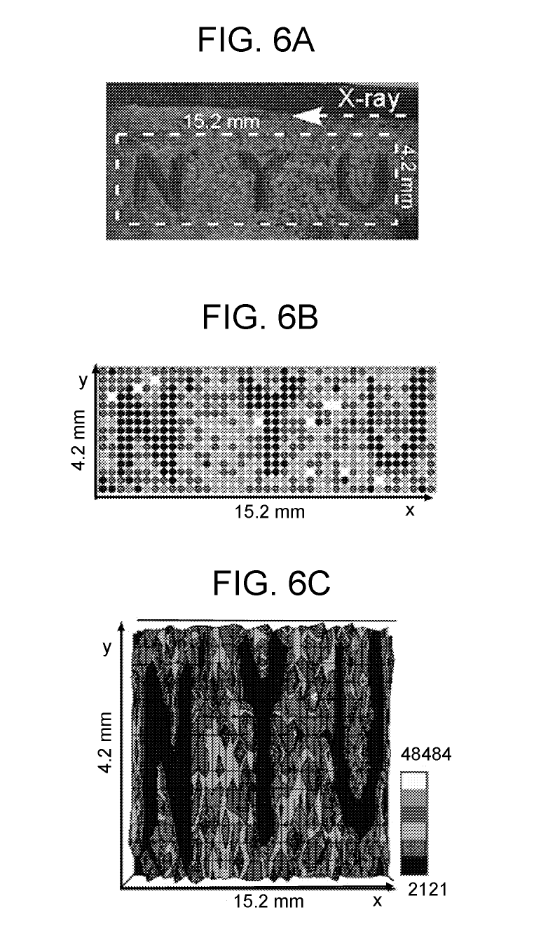

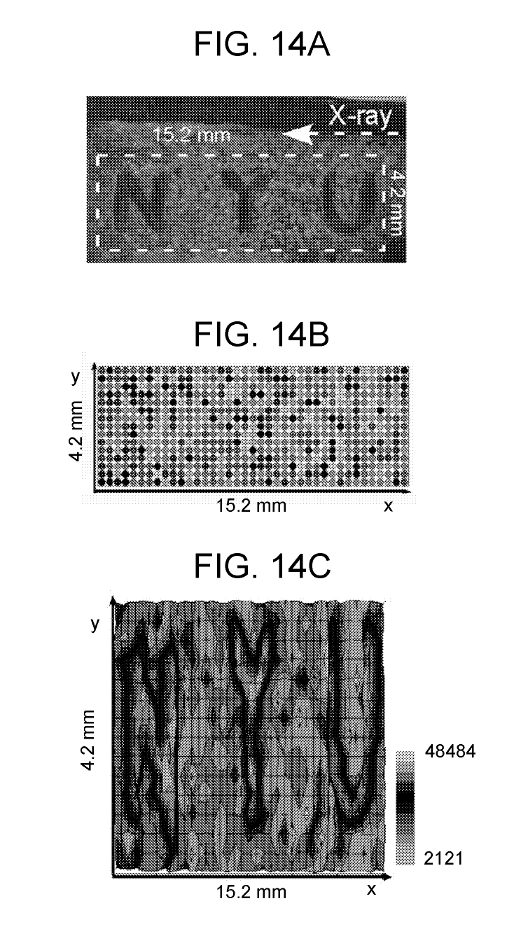

μ-XRD mapping was performed on a rutile “NYU” logo stamped as a negative image on a bare silicon wafer in order to evaluate the mapping protocol on a pattern more complex than a barcode and also on a negative pattern (Table 2, FIG. 6). A silicon wafer was used to evaluate an alternative substrate. Moreover, spreading of the suspension on silicon was less than on the glass substrates, affording a slight improvement in feature quality. The {100} silicon diffraction peaks did not interfere with logo mapping because Bragg scattering from these planes occurred at a 2θ value different than the incident angles chosen for mapping. Data were collected for 180 seconds at each grid point for the (301) reflection at 2θ=69.1° (% crystallinity was measured over the range 68.8°≦2θ≦69.5° for method B). Mapping was performed with the 0.30 mm collimator, and the instrument settings were θ₁=60° and θ₂=5°. The sample was positioned with the logo perpendicular to the major axis length of the elliptical footprint dₘₐⱼₒᵣ=0.35 mm. X-ray beam direction, and a rectangular mapping grid with dimensions X=15.2 mm and Y=4.2 mm with grid points separated by Δx=0.40 mm and Δy=0.30 mm (FIG. 5A) was programmed. The total time required to acquire all μ-XRD patterns was approximately 27 hours. Methods A and B were used to construct 2-D and 3-D plots using the Aₚ at 2θ=69.1° (FIGS. 6C-F) and % crystallinity in the range 68.8°≦2θ≦69.5° (FIG. 14), respectively. The logo was clearly legible with only slight irregularities in the letters.

Mapping Barcodes on Tablets.

The ability to read patterns on glass and silicon substrates described above illustrates the feasibility of the μ-XRD protocol on flat surfaces. Practical anti-counterfeit measures for pharmaceutical tablets, however, require the method to be amenable to curved surfaces as well. This was demonstrated through μ-XRD mapping of patterns created on commercially available tablets of ibuprofen, a nonsteroidal anti-inflammatory drug, and aspirin (acetylsalicylic acid, an analgesic). The ibuprofen tablets were biconvex capsule-shaped with a minor axis length m=6.0 mm and major axis length M=14.4 m. The radius of curvature along m was rₘ=5.0 mm. Along M the surface was flat at the center of the tablet, but curved near the edges of the tablet with radius of curvature R_{M}=5.0 mm. The aspirin tablets were biconvex and round with a diameter of 11.2 mm and a radius of curvature of 18.0 mm.

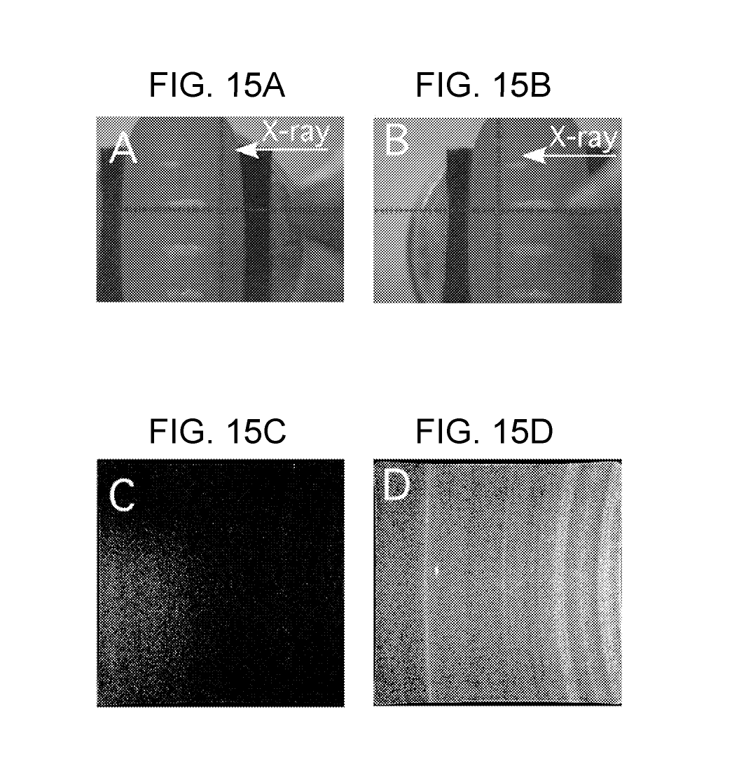

The scattering intensities measured at two points located at opposite sides of a curved tablet, whether diffuse scattering or diffraction from a pattern material, will be inherently different due to absorption of scattered X-rays by tablet when the beam is focused on the side of the tablet nearest the source. The intensity measured by the 2D detector on the side nearest to the source will be lower for the entire 2θ range compared with points on opposite side of the tablet (FIG. 15), resulting in a sloping baseline in the intensity plots on the x-y plane along the direction parallel to the beam. Consequently, the μ-XRD plots generated with Method A, which relies solely on intensity, exhibit higher intensities for those regions of the tablet nearer the detector. This absorption effect, which increases with increasing tablet curvature (high curvature corresponds to a low radius of curvature) and with decreasing θ₂, can be partially compensated by using Method B, which normalizes the Bragg diffraction intensity to the diffuse scattering background. Nonetheless, μ-XRD plots generated with Method B exhibit higher % crystallinity in the region nearer to the X-ray source, where Aₚ and A_{b} are low (eq. 1), and the % crystallinity values decreased for points of the μ-XRD map of areas close to the detector, where Aₚ and A_{b} are high.

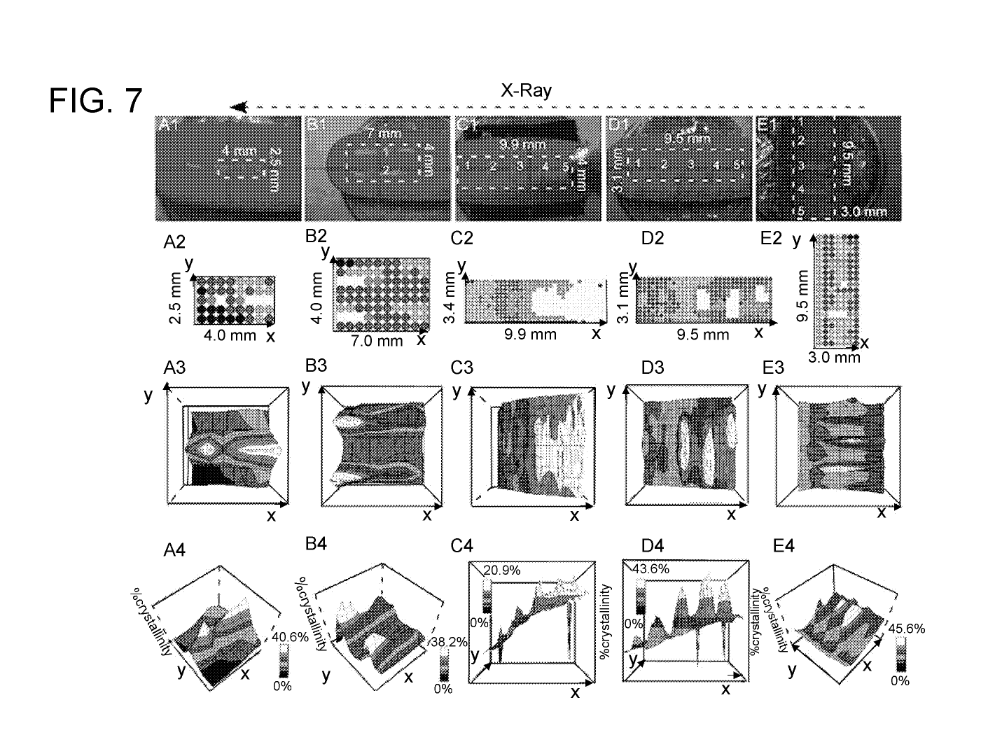

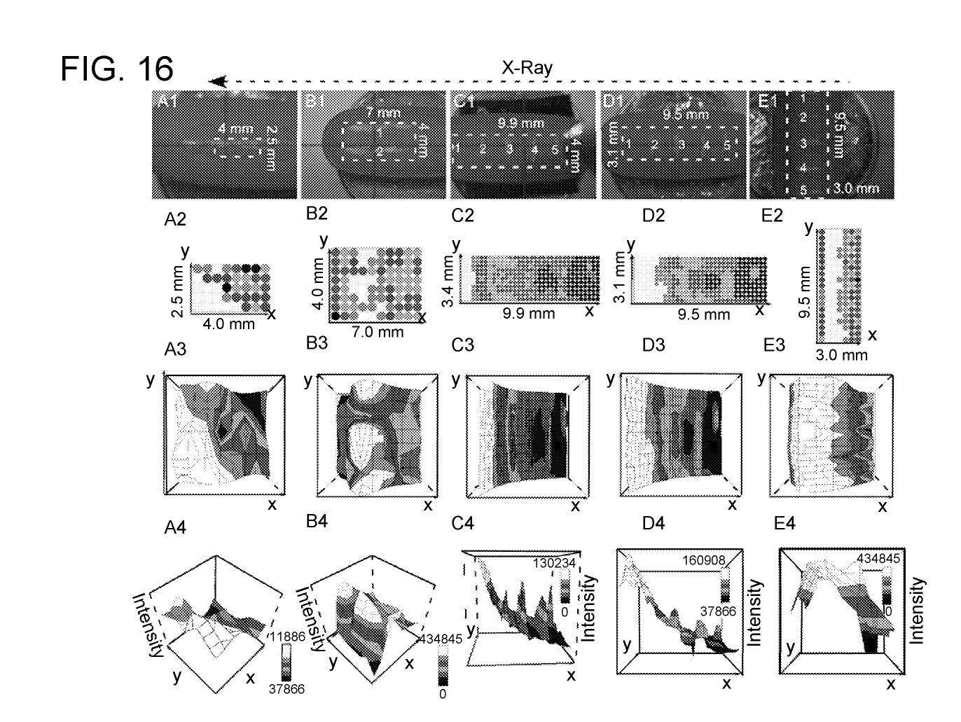

Three capsule-shaped ibuprofen tablets (tablets 1-3) were stamped with 3 different rutile barcodes, and the μ-XRD mapping was performed using the parameters in Table 2. Barcodes of Tablet 1 and 2 consisted of 1 and 2 lines, respectively, stamped along the major M axis (see Table 3 for l, w and i values). Rectangular mapping with dimension X=4.0 mm and Y=2.5 mm for Tablet 1, and X=7.0 mm and Y=4.0 mm, for Tablet 2, were programmed. μ-XRD maps were acquired with the 0.50 mm collimator using either Method A or B and the (110) reflection at 2θ=27.5° (% crystallinity was measured over the range 26.2°≦2θ≦29.1° for method B). The samples were positioned with the barcodes parallel to the major axis of the elliptical X-ray beam footprint dₘₐⱼₒᵣ=1.5 mm. The total time required to acquire all μ-XRD patterns was 1 hour and 20 minutes for Tablet 1, and 2 hours and 40 minutes for Tablet 2. While the μ-XRD plots of Tablet 1 and 2 acquired with method B were faithful replicas of the actual patterns (FIGS. 7A1-B4), method A did not replicate the barcodes (FIG. 16), most likely due to the high curvature of the tablets along the m axis and near the edges. The measurements for Tablets 1 and 2 demonstrated that μ-XRD mapping could be performed on curved surfaces within a reasonably short period of time. A different tablet (Tablet 3) was stamped with a barcode consisting of 5 lines along the m axis (see Table 3 for l, w and i values). In order to investigate the effects of θ₁ on mapping resolution and curvature on intensity, μ-XRD mapping at various combinations of (θ₁, tablet orientation), specifically (60°,∥), (20°,∥), and (20°,⊥), were performed on Tablet 3 (∥ denotes the beam is parallel to the tablet M axis; ⊥ denotes the beam is perpendicular to the tablet M axis). μ-XRD maps at (60°, ⊥) are not reported here as they proved to be inadequate because the small value of θ₂, which is required for the large θ₁, results in large absorption of the scattered X-rays by the tablet. This produced only a partial mapping of the barcode; only the portion of the barcode in the center of the tablet and along the major axis could be read. μ-XRD mappings at the three other settings were performed with the 0.30 mm collimator and rectangular mapping grids with dimensions X=9.9 mm and Y=3.4 mm for (60°,∥), X=9.5 mm and Y=3.1 mm for (20°,∥), and X=9.5 mm and Y=3.0 mm for (20°,⊥). μ-XRD maps were acquired using either method A or B, and either (i) the (110) reflection at 2θ=27.5° (% crystallinity was measured over the range 26.2°≦2θ≦29.1° for method B) for (20°,λ), and (20°,⊥) or (ii) the (301) reflection at 2θ=69.1° (% crystallinity was measured over the range 68.8.2°≦2θ≦69.5° for method B) for (60°,∥). As expected, due to the absorption effect, the μ-XRD plots generated with Method B recorded high % crystallinity in the region near the X-ray source (FIGS. 7C2-7C4, 7D2-7D4 and 7E2-7E4), resulting in 3D plots with curved baselines beneath the barcode readouts (FIGS. 7C4, 7D4, 7E4). The μ-XRD maps acquired at (60°,∥) were faithful replicas of the actual pattern (FIGS. 7D3, 7D4), whereas the μ-XRD maps acquired at (20°,∥) afforded larger w values than actual because of the larger elliptical footprint of the beam and the associated lower mapping resolution (FIGS. 7C3, 7C4). The baseline curvature for the (20°,∥) plots was less prominent owing to the greater value of θ₂ (FIG. 7D4). μ-XRD plots of the (20°,⊥), however, exhibited a more pronounced absorption effect because the lower value of θ₂ (FIGS. 7E1-E4). For (20°,⊥), the difference in % crystallinity (Δ_{cryst}) between the points on opposite sides of the tablet, separated by 3 mm along the m axis, was 16%≦Δ_{cry}≦20%. The corresponding value at the same separation along the M axis for (20°,∥) was 3%≦Δ_{cry}≦6%, demonstrating that the absorption effect scales with the curvature of the tablet. The μ-XRD maps generated with method A were faithful replicas of the actual pattern for (60°,∥), but not for (20°,∥) and (20°,⊥) (FIG. 16).

TABLE 3
List of l, w, i and s parameters (mm) of actual and mapped barcodes printed on
commercial ibuprofen and *aspirin tablets.

| | Tablet 1^{a} | | Tablet 2^{a} | | Tablet 3_{(60°,=)}^{b} | | Tablet 3_{(20°,=)}^{c} | | Tablet 3_{(20°,⊥)}^{c} | | *Tablet 4^{f} | |
|---|---|---|---|---|---|---|---|---|---|---|---|---|
| | A^{g} | B | A^{g} | B | A | B | A | B | A^{g} | B | A | B |
| Actual | 4.0 | 4.0 | 5.7 | 5.7 | 1.0 | 1.0 | 1.0 | 1.0 | 1.0 | 1.0 | 5.0 | 5.0 |
| Map | — | 4.0 | — | 7.0 | — | 0.9 | — | 0.9 | — | 1.0 | 5.1 | 4.2 |
| Actual | — | — | 5.5 | 5.5 | 1.8 | 1.8 | 1.8 | 1.8 | 1.8 | 1.8 | 6.6 | 6.6 |
| Map | — | — | — | 5.6 | 1.8 | 1.8 | — | 1.8 | — | 1.5 | 6.0 | 6.0 |
| Actual | — | — | — | — | 2.2 | 2.2 | 2.2 | 2.2 | 2.2 | 2.2 | — | — |
| Map | — | — | — | — | 2.1 | 1.8 | 1.2-1.8 | 1.8-2.4 | — | 2.5 | — | — |
| Actual | — | — | — | — | 2.2 | 2.2 | 2.2 | 2.2 | 2.2 | 2.2 | — | — |
| Map | — | — | — | — | 2.1 | 2.1 | 1.8-2.1 | 2.1 | — | 2.5 | — | — |
| Actual | — | — | — | — | 1.2 | 1.2 | 1.2 | 1.2 | 1.2 | 1.2 | — | — |
| Map | — | — | — | — | 1.2 | 1.2 | 0.9 | 1.2 | — | 1.0 | — | — |
| Actual | — | — | 1.2-1.5 | 1.2-1.5 | 1.6-1.7 | 1.6-1.7 | 1.6-1.7 | 1.6-1.7 | 1.6-1.7 | 1.6-1.7 | 1.5-1.8 | 1.5-1.8 |
| Map | — | — | — | 1.5 | — | 1.8 | — | 1.2 | — | 1.5 | 1.5-1.8 | 1.5-1.8 |
| Actual | — | — | — | — | 1.5-1.6 | 1.5-1.6 | 1.5-1.6 | 1.5-1.6 | 1.5-1.8 | 1.5-1.6 | — | — |
| Map | — | — | — | — | 1.5 | 1.5 | — | 0.9 | 1.5-1.8 | 1.5 | — | — |
| Actual | — | — | — | — | 1.7 | 1.7 | 1.7 | 1.7 | 1.7 | 1.7 | — | — |
| Map | — | — | — | — | 1.8 | 1.8 | 1.5 | 0.9 | — | 1.5-2.0 | — | — |
| Actual | — | — | — | — | 1.5-1.6 | 1.5-1.6 | 1.5-1.6 | 1.5-1.6 | 1.5-1.6 | 1.5-1.6 | — | — |
| Map | — | — | — | — | 1.5 | 1.8 | 1.2 | 0.9-1.2 | — | 1.5 | — | — |
| Actual | 0.3-0.5 | 0.3-0.5 | 0.5-0.7 | 0.5-0.7 | 0.3 | 0.3 | 0.3 | 0.3 | 0.3 | 0.3 | 0.4-0.7 | 0.4-0.7 |
| Map | — | 0.5 | — | 0.5-1.0 | — | 0.3 | — | 0.6 | — | 0.5 | 0.3-0.6 | 0.3-0.6 |
| Actual | — | — | 0.2-0.7 | 0.2-0.7 | 0.4 | 0.4 | 0.4 | 0.4 | 0.4 | 0.4 | 0.4-0.7 | 0.4-0.7 |
| Map | — | — | — | 0.5 | 0.6-0.9 | 0.6 | — | 1.2 | — | 0.5 | 0.3-0.6 | 0.3-0.6 |
| Actual | — | — | — | — | 0.7 | 0.7 | 0.7 | 0.7 | 0.7 | 0.7 | — | — |
| Map | — | — | — | — | 0.3-0.6 | 0.3-0.6 | 0.9 | 1.2 | — | 0.5-1.0 | — | — |
| Actual | — | — | — | — | 0.5 | 0.5 | 0.5 | 0.5 | 0.5 | 0.5 | — | — |
| Map | — | — | — | — | 0.3-0.6 | 0.3-0.6 | 0.9 | 0.6 | — | 0.5 | — | — |
| Actual | — | — | — | — | 0.4 | 0.4 | 0.4 | 0.4 | 0.4 | 0.4 | — | — |
| Map | — | — | — | — | 0.3-0.6 | 0.3-0.6 | 0.6 | 0.6-0.9 | — | 0.5 | — | — |

μ-XRD maps acquired
^{a}at θ₁ = θ₂ = 20° for 120 seconds at each grid point using the 0.5 mm diameter collimator (dₘₐⱼₒᵣ = 1.5 mm),
^{b}at θ₁ = 60° and θ₂ = 5° for 200 seconds at each grid point using the 0.3 mm diameter collimator (dₘₐⱼₒᵣ = 0.35 mm),
^{c}at θ₁ = θ₂ = 20° for 120 seconds at each grid point using the 0.3 mm diameter collimator (dₘₐⱼₒᵣ = 0.87 mm), ) and
^{d}at θ₁ = 60° and θ₂ = 5° for 180 seconds at each grid point using the 0.3 mm diameter collimator (dₘₐⱼₒᵣ = 0.35 mm).
^{g}The μ-XRD method did not reproduce the correct pattern.

θ₂=5° for 180 seconds at each grid point using the 0.3 mm diameter collimator (dₘₐⱼₒᵣ=0.35 mm).^{g} The μ-XRD method did not reproduce the correct pattern.

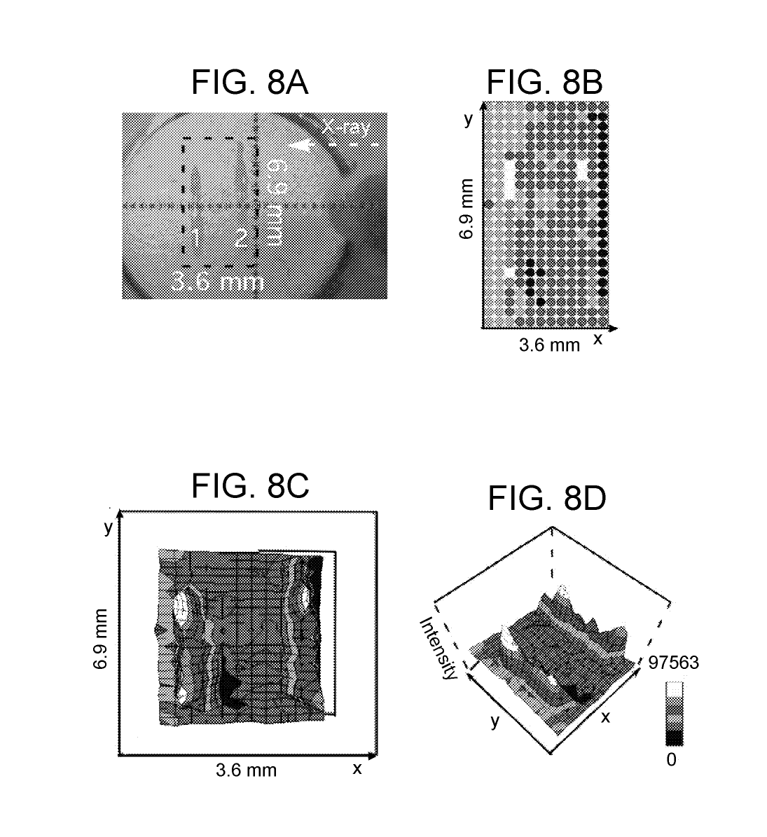

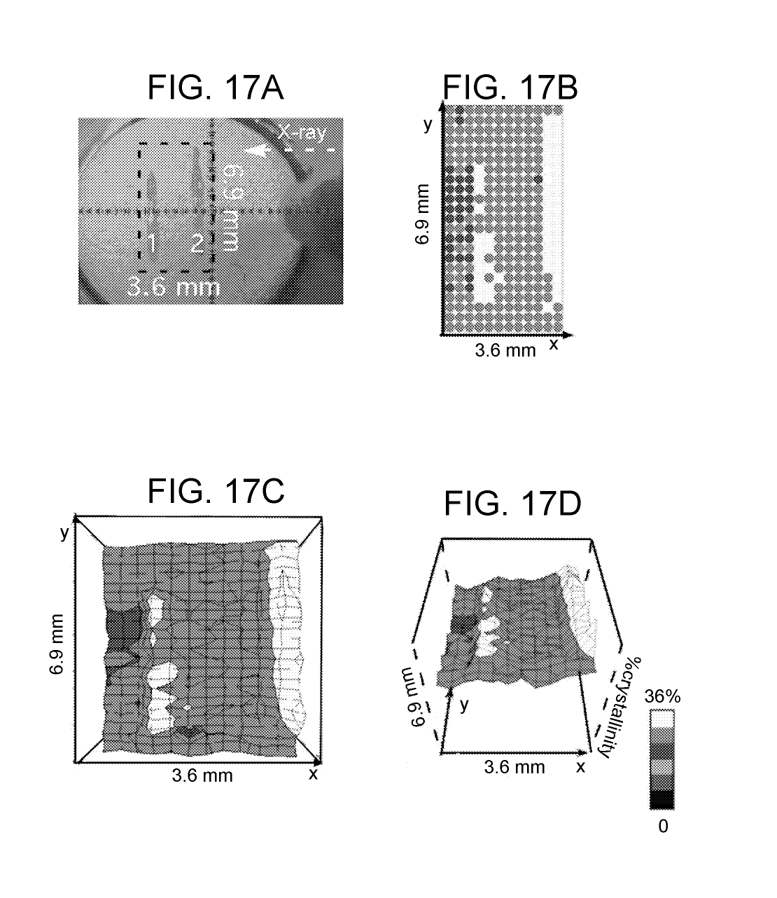

A μ-XRD map was acquired for a pattern stamped onto a commercial tablet of aspirin (Tablet 4) to evaluate the feasibility of the protocol on a differently shaped tablet. Tablet 4 (FIG. 8A) was stamped with a rutile barcode consisting of 2 lines (see Table 3 for l, w and i values), and the μ-XRD mapping was performed using the parameters given in Table 4 and a rectangular mapping grid with X=3.6 mm and Y=6.9 mm. The μ-XRD maps were acquired with the 0.30 mm collimator using method A or B and the (301) reflection at 2θ=69.1° (% crystallinity was measured over the range 68.8°≦2θ≦69.5° for method B). The sample was positioned with the barcodes perpendicular to the major axis of the elliptical footprint (dₘₐⱼₒᵣ=0.35 mm). The μ-XRD maps were faithful replicas of the actual pattern (FIGS. 8, 17).

TABLE 4
Parameters used for μ-XRD experiments performed on
ibuprofen and aspirin tablets.

| | | | | Time × | | |
|---|---|---|---|---|---|---|
| | θ₁ | θ₂ | Map Area | scan | Δx | Δy |
| Tablet | (degrees) | (degrees) | (mm²) | (sec) | (mm) | (mm) |
| 1 | 20 | 20 | 10 | 120 | 0.50 | 0.50 |
| 2 | 20 | 20 | 28 | 120 | 0.70 | 0.70 |
| 3 (60°, \|\|) | 60 | 5 | 34 | 200 | 0.30 | 0.30 |
| 3 (20°, \|\|) | 20 | 20 | 29 | 120 | 0.30 | 0.30 |
| 3 (20°, ⊥) | 20 | 20 | 29 | 120 | 0.50 | 0.50 |
| 4 | 60 | 5 | 25 | 180 | 0.30 | 0.30 |

### Summary

The μ-XRD protocol herein developed prove to be practical for mapping patterns fabricated with FDA-approved compounds, detectable by X-ray diffraction, stamped on flat surfaces and on commercial tablets. Because the X-ray beam can penetrate polymer films and tablet coatings easily, the protocol can be employed as anti-counterfeit method to verify concealed patterns stamped by authorized manufacturers of genuine products. A variety of X-ray detectable compounds such as rutile, zinc oxide, magnesium oxide and iron oxide could be used alone in a given barcode or trademark, or they can combined in a pattern to introduce an added level of complexity that would further deter counterfeiting. Although the results described herein relied on patterns that were applied manually using soft lithography stamping, the protocol is amenable to alternative printing methods that would produce patterns with higher quality and reproducibility that would be required for commercial use. The mapping resolution and acquisition time of the μ-XRD protocol can be optimized by adjusting key parameters (D_{c}, θ₁, n_{gp}, t, Δx and Δy) for tablets, as well as packages and containers. The protocol is completely automated, non-destructive, and easy to use for inexperienced employees. Although the typical mapping times described herein may seem long compared to conventional anti-counterfeit methods that rely on optical microscopy or vibrational spectroscopy, these methods can be circumvented more easily than the μ-XRD protocol. The μ-XRD protocol relies on verification of phase, composition, and pattern readout in a single measurement, further reducing the risk of circumvention compared with methods such as mass spectroscopy and HPLC, which rely on composition measurements alone. Moreover, the limited number of microdiffractometers makes this analytical method a useful tool to track and identify counterfeiters attempting to undermine this approach to product protection.

### Example 2

### Collimator Intensity Test

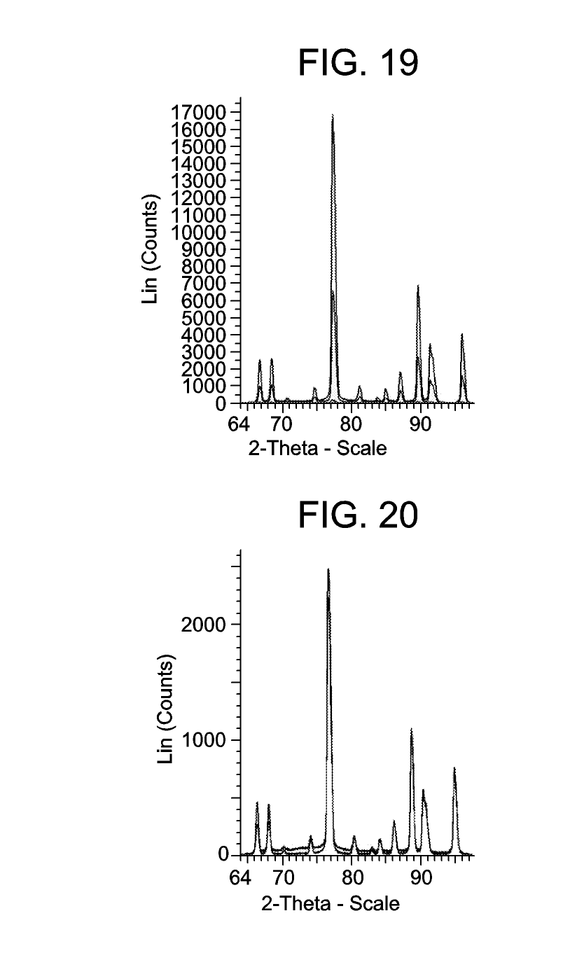

Collimators with a diameter of 500 μm, 300 μm, 50 μm and 10 μm were mounted on the Bruker D8 DISCOVER General Area Detector Diffraction System (GADDS) equipped with a VANTEC-2000 area detector, a x-y-z translational sample stage. Micro-XRD experiments were performed on corundum, the diffraction patterns were collected for 1 hour at θ₁=60° and θ₂=20° (FIG. 19), and the intensities of the peak at 2-theta 76.9° were compared (Table 5).

TABLE 5
Micro-XRD maximum intensities of the diffraction
peak of corundum at 76.9° collected at θ₁ =
60° and θ₂ = 20° for 1 hour with different collimators.

| Collimator | Intensity^{a} | Intensity^{a} |
|---|---|---|
| diameter (μm) | (Counts) | (%) |
| 500 | 17891 | 100 |
| 300 | 6982 | 39 |
| 50 | 191 | 1.07 |
| 10 | 6 | 0.03 |

^{a}Maximum Intensity of corundum peak at 76.9°

Polyethylene Film Micro-XRD Experiments.

Micro X-ray diffraction experiments were performed on corundum, the diffraction patterns were collected for 10 minutes at θ₁=60° and θ₂=20° with the sample covered with 6 layers of polyethylene film 15 μm thick (FIG. 8), and the intensities of the peak at 2-θ76.9° were compared (Table 6).

TABLE 6
Micro-XRD maximum intensities of the diffraction peak
at 76.9° of corundum covered with layers of polyethylene
film 15 μm thick collected at θ₁ = 60° and
θ₂ = 20° for 10 minutes with 500 μm collimator.

| N^{a} | Intensity^{b} (Counts) | Intensity^{b} (%) |
|---|---|---|
| 0 | 2645 | 100 |
| 1 | 2624 | 99.2 |
| 2 | 2574 | 97.3 |
| 3 | 2544 | 96.2 |
| 4 | 2507 | 94.8 |
| 5 | 2447 | 92.5 |
| 6 | 2434 | 92.0 |

^{a}Number of polyethylene layers 15 μm tick.
^{b}Maximum Intensity of corundum peak at 76.9°

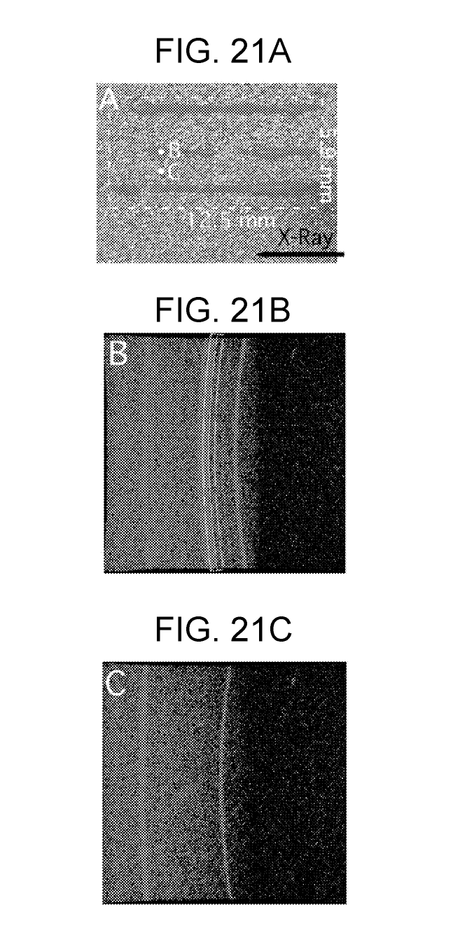

Micro-XRD experiments of zinc oxide on anatase. A zinc oxide barcode was printed on a glass slide covered in anatase, and a micro-XRD mapping experiment was performed. The barcode was made by 3 parallel bars 200-800 μm wide, 10 mm, 8.8 mm and 10.8 mm long and separated by 1.5 mm and 1.9 mm. A rectangular mapping grid 12.5 mm large and 5.9 mm high was set up with grid points separated vertically by 300 μm and horizontally by 400 μm (FIG. 21). Micro-XRD patterns were collected automatically for 120 seconds at each grid point using the 300 μm diameter collimator and setting the θ₁ angle at 60°. The software GADDS calculated the percent crystallinity in the range of 66.5°-68.6° for each diffraction pattern collected, and the software GADDSMap built 2-D and 3-D maps with white and yellow colors being high percent crystallinity grid points, and red and maroon being low percent crystallinity grid points (FIG. 4). The calculated micro-XRD maps had 3 horizontal bars 24, 22 and 27 grid points long (9.6 mm, 8.8 mm and 10.8 mm), and 1-3 grid points large (300-900 μm) (FIG. 4B). The distances between the bars were 5-6 grid points (1.5-1.8) and 4-5 grid points (1.2-1.5), matching the features on the real surface (FIG. 10).

Micro-XRD Experiments on Ibuprofen and Aspirin Tablets.

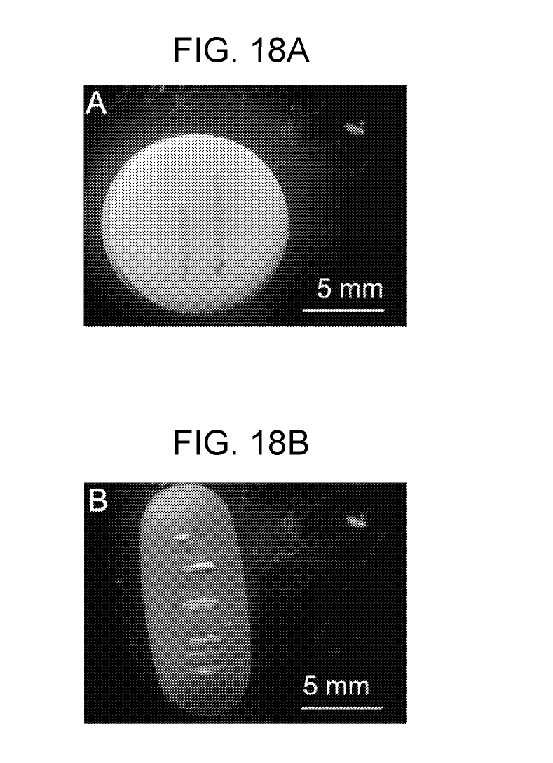

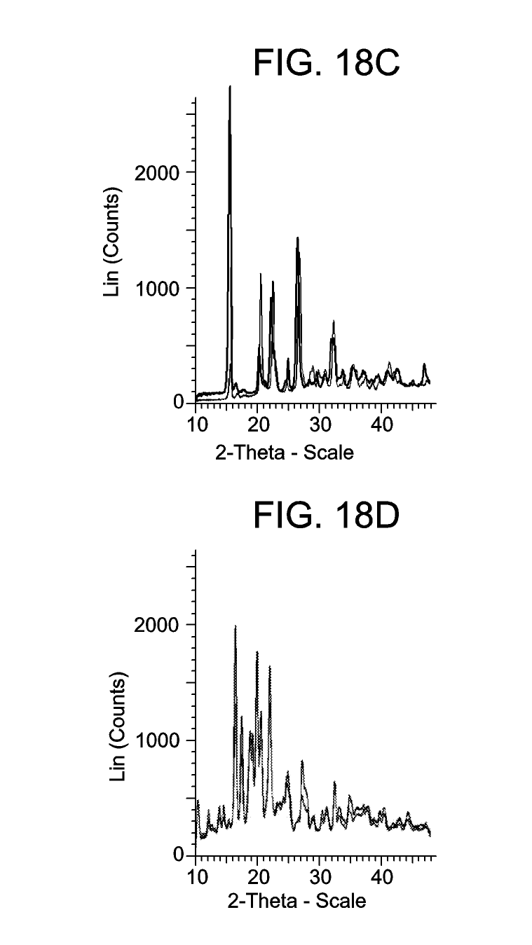

Micro-XRD experiments were performed on the external surface of ibuprofen and aspirin tablets, and micro-XRD patterns were collected for 180 seconds using the 300 μm diameter collimator at θ₁=θ₂=15° (FIG. 18). The tablets were cut in half, and micro-XRD patterns of the tablet cross section were collected for 180 seconds using the 300 μm diameter collimator at θ₁=θ₂=15° (FIG. 18).

We claim:

1. A method for identifying an authentic or original article by
A) providing a mark on the article that may be identified by micro x-ray diffraction;
B) providing x-ray radiation to identify the mark;
C) analyzing the presence of or position of the mark on the article; and
D) determining whether the mark is substantially identical to the mark provided in A).

2. The method of claim 1 wherein the presence of or position of the mark is identified with respect to one-dimension or two-dimensions.

3. The method of claim 1 wherein the presence of or position of the mark is identified using an x-ray micro-diffractometer.

4. The method of claim 1 wherein the article is a drug such as a tablet, pill or capsule.

5. The method of claim 1 wherein the article is a drug such as a tablet, pill or capsule and the mark is present on the surface thereof or on a package or an envelope.

6. The method of claim 1 wherein the mark is not visible by eye.

7. The method of claim 1 wherein the mark is made of a substance selected from the group consisting of rutile, zinc oxide, magnesium oxide, talc and iron oxide.

8. A method for identifying a counterfeit article or a copy of an original article by
A) providing a mark on a first original article that may be identified by micro x-ray diffraction;
B) providing x-ray radiation to identify the mark;
C) providing a first original article or a second counterfeit article or copy of the first original article;
D) analyzing the presence of or the position of the mark on the article; and
E) determining whether the mark is substantially identical to the mark provided in A).

9. The method of claim 8 wherein the presence of or position of the mark is identified with respect to one-dimension or two-dimensions.

10. The method of claim 8 wherein the presence of or position of the mark is identified using an x-ray micro-diffractometer.

11. The method of claim 8 wherein the article is a drug such as a tablet, pill or capsule.

12. The method of claim 8 wherein the article is a drug such as a tablet, pill or capsule and the mark is present on the surface thereof or on a package or an envelope.

13. The method of claim 8 wherein the mark is not visible by eye.

14. An article having a mark wherein the mark is made of an X-ray visible compound that may be read by a micro-diffractometer.

15. An article according to claim 14 wherein the mark is selected from the group consisting of rutile, zinc oxide, magnesium oxide, talc and iron oxide.

16. An article according to claim 14 wherein the mark is substantially hidden underneath a coating.

17. An article according to claim 14 wherein the mark forms a substantial bar code.

18. An article according to claim 14 wherein the mark is invisible to the eye.

19. An article according to claim 14 wherein the mark is present on a package, envelope or wrapping.
